(19) United States
(12) Patent Application Publication
(10) Pub. No.: US 2018/0297445 A1
(43) Pub. Date: Oct. 18, 2018

(54) VEHICLE HEAT MANAGEMENT DEVICE

(71) Applicant: TOYOTA JIDOSHA KABUSHIKI KAISHA, Toyota-shi (JP)

(72) Inventors: Yoichi ONISHI, Okazaki-shi (JP); Keisuke Shibata, Miyoshi-shi (JP); Yoshikazu Shinpo, Nissin-shi (JP); Kei Okamoto, Toyota-shi (JP); Tomohiro Shinagawa, Nagaizumi-shi (JP); Hidefumi Aikawa, Nagaizumi-shi (JP); Masaki Suzuki, Miyoshi-shi (JP); Nobuharu Kakehashi, Toyoake-shi (JP)

(73) Assignee: TOYOTA JIDOSHA KABUSHIKI KAISHA, Toyota-shi (JP)

(21) Appl. No.: 15/900,824

(22) Filed: Feb. 21, 2018

(30) Foreign Application Priority Data
Apr. 12, 2017 (JP) 2017-079303

(51) Int. Cl. B60H 1/00; B60H 3/02; B60H 1/12

(52) U.S. Cl. CPC B60H 1/00892; B60H 1/00921; B60H 1/00278; B60H 1/00271; B60H 2001/3285; B60H 1/12; B60H 2001/00928; B60H 2001/00307; B60H 3/024

(57) ABSTRACT

A vehicle heat management device includes a first circulator section, a second circulator section, and a flow rate change section. The first circulator section is provided at a first flow path of a first circulation path, and circulates a first heat exchange medium in the first circulation path, the first flow path passing a first heat exchanger, a second flow path passing a first expansion valve and a second heat exchanger, a third flow path passing a second expansion valve and a heat absorption section. The second circulator section circulates a second heat exchange medium in a second circulation path configured by a fourth flow path passing a heat generating body, a fifth flow path passing a radiator, and a sixth flow path passing a heat dissipating section and the first heat exchanger. The flow rate change section increases a flow rate of the second heat exchange medium.

### CROSS-REFERENCE TO RELATED APPLICATION

This application claims priority under 35 USC 119 from Japanese Patent Application No. 2017-079303 filed Apr. 12, 2017, the disclosure of which is incorporated by reference herein.

### BACKGROUND

### Technical Field

The present description relates to a vehicle heat management device.

### Related Art

Japanese Patent Application Laid-Open (JP-A) No. 2013-244844 describes a vehicle heat pump air-conditioning system capable of performing dehumidifying-heating operation. In this system, cooling medium discharged from a compressor passes in sequence through a three-way switching valve, a vehicle interior condenser that heats air blown into the vehicle, and a receiver, and then branches into two paths. One path is a path passing through a first decompression unit with valve open/close functionality and a vehicle interior evaporator that cools air blown into the vehicle interior before returning to the compressor. The other path is a path passing through a second decompression unit with valve open/close functionality and a vehicle exterior evaporator before returning to the compressor. In the technology of JP-A No. 2013-244844, the revolution speed of the compressor is increased/decreased to control the circulation flow rate of the cooling medium such that the temperature of the air blown into the vehicle is changed accompanying changing of a setting temperature. The first decompression unit is thereby opened and closed according to the temperature of the air blown from the vehicle interior evaporator.

However, in the technology in JP-A No. 2013-244844, when the revolution speed of the compressor is decreased due to the temperature of the air blown into the vehicle getting close to the setting temperature or having reached the setting temperature, the flow rate of the cooling medium passing through the vehicle interior evaporator also decreases, and dehumidification performance therefore cannot be maintained. Thus, in the technology in JP-A No. 2013-244844, an issue arises in that air-conditioning cannot be achieved as demanded in cases in which the heating demand decreases relative to the dehumidification demand in dehumidifying-heating operation.

In particular, in cases in which dehumidifying-heating was being performed in an internal air circulation mode, when the vehicle cabin temperature rises and the amount of saturated water vapor increases, the moisture content within the air in the vehicle cabin increases as a result of water vapor contained in the breath of occupants, sweat from the occupants, evaporation of condensation on the windows, and so on. Thus, when the vehicle cabin temperature rises as time passes since starting the dehumidifying-heating in the internal air circulation mode, the dehumidification demand tends to increase as the heating demand decreases. Accordingly, in the dehumidifying-heating operation, a decrease in the heating demand relative to the dehumidification demand may occur with high frequency.

Note that the issue described above is not limited to the dehumidifying-heating operation of an air-conditioning device. Namely, in cases in which, in a state in which heat absorption is performed by a heat absorber and heat dissipation is performed by a heat dissipater inside a vehicle, a heat dissipation demand in the heat dissipater decreases relative to a heat absorption demand in the heat absorber, the technology described in JP-A No. 2013-244844 is not capable of achieving the demanded heat management.

### SUMMARY

The present description realizes heat management according to demand when, in a state in which heat absorption is being performed in a heat absorption section inside a vehicle and heat dissipation is being performed in a heat dissipating section, the heat dissipation demand in the heat dissipating section has decreased relative to the heat absorption demand in the heat absorption section.

A vehicle heat management device of a first aspect of the present description includes a first circulator section, a second circulator section, and a flow rate change section. The first circulator section is provided at a first flow path of a first circulation path and circulates a first heat exchange medium in the first circulation path. The first flow path passes a primary side of a first heat exchanger capable of exchanging heat between the primary side and a secondary side. A second flow path passes a first expansion valve and a second heat exchanger disposed at a cabin exterior, and a third flow path passes a second expansion valve and a heat absorption section disposed inside a vehicle. The first flow path is connected in parallel to the second flow path and the third flow path. The second circulator section circulates a second heat exchange medium in a second circulation path. The second circulation path is configured by a fourth flow path passing a heat generating body of the vehicle, a fifth flow path passing a radiator, and a sixth flow path passing a heat dissipating section disposed inside the vehicle and the secondary side of the first heat exchanger. The fourth flow path, the fifth flow path, and the sixth flow path are connected in parallel with each other. From a first state in which a heat exchange is being performed in the first heat exchanger, a heat absorption is being performed in the second heat exchanger and the heat absorption section, and a heat dissipation is being performed in the heat dissipating section, in cases in which the heat dissipation demand in the heat dissipating section has decreased relative to the heat absorption demand in the heat absorption section, the flow rate change section increases the flow rate of the second heat exchange medium in the fifth flow path of the second circulation path.

In the first aspect, the first circulator section circulates the first heat exchange medium in the first circulation path in which the second flow path and the third flow path are connected in parallel to the first flow path. The first flow path of the first circulation path passes the primary side of the first heat exchanger that is capable of exchanging heat between the primary side and the secondary side. The second flow path passes the first expansion valve and the second heat exchanger disposed at the cabin exterior, and the third flow path passes the second expansion valve and the heat absorption section inside a vehicle. Moreover, in the first aspect, the second circulator section circulates the second heat exchange medium in the second circulation path. The second circulation path is configured by the fourth flow path, the fifth flow path, and the sixth flow path connected in parallel to each other. In the second circulation path, the fourth flow path passes the heat generating body of the vehicle, the fifth flow path passes the radiator, and the sixth flow path passes the heat dissipating section inside the vehicle and the secondary side of the first heat exchanger.

In the above configuration, the heat absorption section absorbing heat and the heat dissipating section dissipating heat is realized in a first state in which the heat exchange is being performed in the first heat exchanger, the heat absorption is being performed in the second heat exchanger and the heat absorption section, and the heat dissipation is being performed in the heat dissipating section. From this first state, in cases in which the heat dissipation demand in the heat dissipating section has decreased relative to the heat absorption demand in the heat absorption section, the flow rate change section increases the flow rate of the second heat exchange medium in the fifth flow path of the second circulation path.

While maintaining the amount of heat absorption in the heat absorption section of the first circulation path, the amount of heat dissipation in the heat dissipating section of the second circulation path is decreased by increasing the proportion of heat that is dissipated in the radiator on the fifth flow path of the second circulation path out of the heat that is transferred from the first heat exchange medium to the second heat exchange medium in the first heat exchanger. The first aspect thereby enables heat management according to demand to be realized when, in a state in which heat absorption is being performed in the heat absorption section inside the vehicle and heat dissipation is being performed in the heat dissipating section, the heat dissipation demand in the heat dissipating section has decreased relative to the heat absorption demand in the heat absorption section.

Note that in the first aspect, the flow rate change section may, for example, as in a vehicle heat management device of a second aspect of the present description, include a first flow rate regulating section capable of regulating the flow rate of the second heat exchange medium in the fifth flow path of the second circulation path, and a first control section. In cases in which, from the first state, the heat dissipation demand in the heat dissipating section has decreased relative to the heat absorption demand in the heat absorption section, the first control section controls the first flow rate regulating section to increase the flow rate of the second heat exchange medium in the fifth flow path.

In the second aspect, for example, as in a vehicle heat management device of a third aspect of the present description, the first flow rate regulating section may include a flow rate regulating valve provided at the fifth flow path, with the first control section increasing an opening amount of the flow rate regulating valve to increase the flow rate of the second heat exchange medium in the fifth flow path.

In the second aspect, for example, as in a vehicle heat management device of a fourth aspect of the present description, the first flow rate regulating section may include an electric thermostat that is provided at the fifth flow path and that is capable of changing a valve-opening temperature, with the first control section decreasing the valve-opening temperature of the electric thermostat to increase the flow rate of the second heat exchange medium in the fifth flow path of the second circulation path.

In the first aspect, the flow rate change section may, for example, as in a vehicle heat management device of a fifth aspect of the present description, include a mechanical thermostat provided at the fifth flow path.

A vehicle heat management device of a sixth aspect of the present description is any one of the first to the fifth aspects, further including a second control section that, in cases in which in the first state the heat dissipation demand in the heat dissipating section has decreased relative to the heat absorption demand in the heat absorption section, controls the first expansion valve so as to either decrease a flow rate or stop circulation of the first heat exchange medium in the second flow path of the first circulation path.

As described above, in the first state of the present description, heat absorption is performed in the second heat exchanger and the heat absorption section of the first circulation path, heat is transferred from the first heat exchange medium to the second heat exchange medium in the first heat exchanger, and heat dissipation is performed in the heat dissipating section of the second circulation path. In the first circulation path, the amount of heat transferred from the first heat exchange medium to the second heat exchange medium in the first heat exchanger is the sum total of the amount of heat absorbed in the second heat exchanger, the amount of heat absorbed in the heat absorption section, and the work done by the first circulator section. Among these, the amount of heat absorbed in the second heat exchanger can be regulated by changing the flow rate of the first heat exchange medium passing through the second heat exchanger.

In the sixth aspect, in cases in which, in the first state, the heat dissipation demand in the heat dissipating section has decreased relative to the heat absorption demand in the heat absorption section, the first expansion valve is controlled so as to either decrease the flow rate or stop circulation of the first heat exchange medium in the second flow path of the first circulation path. Accordingly, while maintaining the amount of heat absorption in the heat absorption section of the first circulation path, the amount of amount of heat absorption in the second heat exchanger is decreased, causing an accompanying decrease in the amount of heat transfer from the first heat exchange medium to the second heat exchange medium in the first heat exchanger, thereby enabling the amount of heat dissipation in the heat dissipating section of the second circulation path to be decreased. The sixth aspect thereby enables heat management according to demand to be reliably realized when, in a state in which heat absorption is being performed in the heat absorption section inside the vehicle and heat dissipation is being performed in the heat dissipating section, the heat dissipation demand in the heat dissipating section has decreased relative to the heat absorption demand in the heat absorption section.

A vehicle heat management device of a seventh aspect of the present description is any one of the second to the fourth aspects, further including a second control section that, in cases in which in the first state the heat dissipation demand in the heat dissipating section has decreased relative to the heat absorption demand in the heat absorption section, controls the first expansion valve so as to decrease a flow rate of the first heat exchange medium in the second flow path of the first circulation path before the first control section controls the first flow rate regulating section to increase the flow rate of the second heat exchange medium in the fifth flow path.

In the seventh aspect, in cases in which in the first state the heat dissipation demand in the heat dissipating section has decreased relative to the heat absorption demand in the heat absorption section, control similar to that of the sixth aspect is performed before controlling the first flow rate regulating section so as to increase the flow rate of the second heat exchange medium in the fifth flow path. Thus, the amount of work done by the first circulator section can be suppressed, thereby improving energy usage efficiency, compared to cases in which control is performed so as to decrease the flow rate of the first heat exchange medium in the second flow path after controlling so as to increase the flow rate of the second heat exchange medium in the fifth flow path.

In any one of the first to the seventh aspects, for example, as in a vehicle heat management device of an eighth aspect of the present description, the heat generating body may include an engine installed in the vehicle, and the second circulation path may include a bypass flow path that bypasses the engine, and a second flow rate regulating section capable of regulating the flow rate of the second heat exchange medium in the fourth flow path. In cases in which engine warm-up is required, this enables warm-up of the engine to be completed in a short period of time by the second flow rate regulating section decreasing the flow rate of the second heat exchange medium in the fourth flow path and increasing the flow rate of the second heat exchange medium in the bypass flow path.

In any one of the first to the eighth aspects, for example, as in a vehicle heat management device of a ninth aspect of the present description, the heat absorption section may include an evaporator disposed together with the heat dissipating section in a duct through which airflow supplied into a vehicle cabin passes. In such cases, the first state may be a dehumidifying-heating operation state in which airflow that has been dehumidified by the evaporator and heated by the heat dissipating section is supplied into the vehicle cabin.

In any one of the first to the ninth aspects, for example, as in a vehicle heat management device of a tenth aspect of the present description, the heat absorption section may include a third heat exchanger for cooling a battery installed to the vehicle.

### BRIEF DESCRIPTION OF THE DRAWINGS

Exemplary Embodiments of the present description will be described in detail based on the following figures, wherein:

FIG. 1 is a schematic configuration diagram of a vehicle heat management system according to a first exemplary embodiment;

FIG. 2 is a schematic block diagram of portions of a vehicle onboard system that are related to a vehicle heat management system according to the first exemplary embodiment;

FIG. 3 is a schematic diagram illustrating the flow of a first heat exchange medium and cooling water in a heating operation;

FIG. 4 is a schematic diagram illustrating the flow of a first heat exchange medium in a cooling operation;

FIG. 5 is a flowchart illustrating dehumidifying-heating operation processing according to the first exemplary embodiment;

FIG. 6 is a schematic diagram illustrating the flow of a first heat exchange medium and cooling water at an early stage of dehumidifying-heating operation (a stage before a heating demand decreases);

FIG. 7 is a schematic diagram illustrating the flow of a first heat exchange medium and cooling water at a late stage of dehumidifying-heating operation (a stage after a heating demand has decreased);

FIG. 8 is a p-h diagram of a vehicle heat management system according to an exemplary embodiment;

FIG. 9 is a schematic configuration diagram of a vehicle heat management system according to a second exemplary embodiment;

FIG. 10 is a schematic block diagram of portions of a vehicle onboard system related to a vehicle heat management system according to the second exemplary embodiment;

FIG. 11 is a flowchart illustrating dehumidifying-heating operation processing according to the second exemplary embodiment;

FIG. 12 is a schematic configuration diagram of a vehicle heat management system according to a third exemplary embodiment;

FIG. 13 is a schematic block diagram of portions of a vehicle onboard system related to a vehicle heat management system according to the third exemplary embodiment;

FIG. 14 is a schematic configuration diagram of a vehicle heat management system according to a fourth exemplary embodiment;

FIG. 15 is a schematic block diagram of portions of a vehicle onboard system related to a vehicle heat management system according to the fourth exemplary embodiment;

FIG. 16 is a flowchart illustrating heat absorption-heating operation processing according to the fourth exemplary embodiment;

FIG. 17 is a schematic configuration diagram of a vehicle heat management system according to a comparative example; and

FIG. 18 is a p-h diagram of a vehicle heat management system according to the comparative example, in a case in which heat is dissipated by a cabin-external heat exchanger.

### DETAILED DESCRIPTION

First, explanation follows regarding a comparative example of the present description before explanation regarding exemplary embodiments of the present description.

### COMPARATIVE EXAMPLE

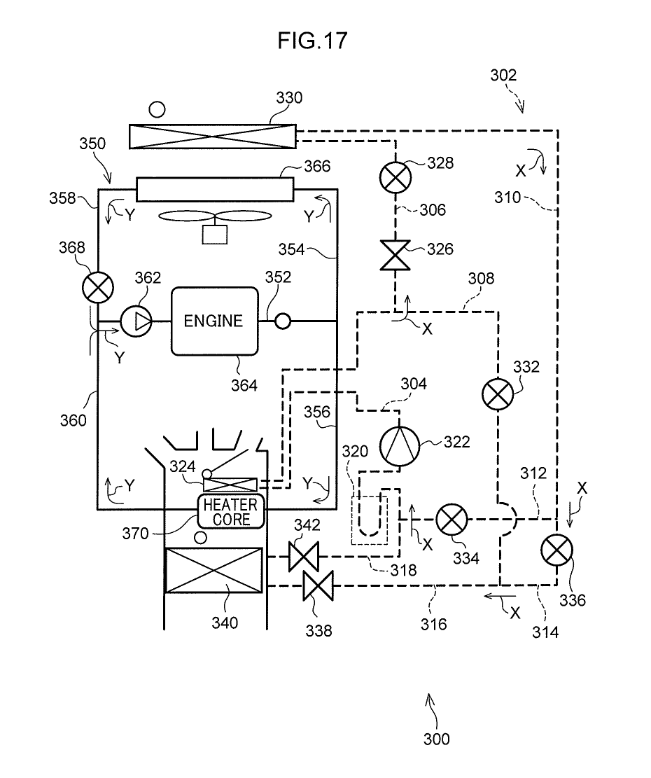

FIG. 17 illustrates a vehicle heat management system 300 according to the comparative example. The vehicle heat management system 300 includes an air-conditioning device that circulates a cooling medium in a heat exchange medium circulation path 302 in order to air-condition a vehicle cabin interior, and a cooling water management device that circulates cooling water in a cooling water circulation path 350 to cool an engine 364 of the vehicle. Note that in FIG. 17, the heat exchange medium circulation path 302 is illustrated by dashed lines, and the cooling water circulation path 350 is illustrated by solid lines.

The heat exchange medium circulation path 302 includes a pipe 304. An accumulator tank 320, a compressor 322 that compresses cooling medium, and an air-heating heat exchanger 324 are provided along the pipe 304, in sequence from an upstream side of a circulation direction of the cooling medium. Another end of the pipe 304 is connected to both one end of a pipe 306 and one end of a pipe 308, and cooling medium discharged from the compressor 322 passes through the air-heating heat exchanger 324 and flows into the pipes 306, 308.

Another end of the pipe 306 is connected to a heat-exchange-medium inflow side of an exterior heat exchanger 330, and an electric first expansion valve 326 and a first solenoid valve 328 are provided in sequence along the pipe 306. The exterior heat exchanger 330 is disposed at a vehicle front side of a radiator 366. Further, one end of a pipe 310 is connected to a heat-exchange-medium outflow side of the exterior heat exchanger 330, and the other end of the pipe 310 is connected to both one end of a pipe 312 and one end of a pipe 314. Another end of the pipe 312 is connected to another end of the pipe 304, and a third solenoid valve 334 is provided partway along the pipe 312.

On the other hand, another end of the pipe 308 is connected to both another end of the pipe 314 and one end of a pipe 316. A second solenoid valve 332 is provided partway along the pipe 308, and a fourth solenoid valve 336 is provided partway along the pipe 314. Another end of the pipe 316 is connected to a heat exchange medium inflow side of an evaporator 340, and an electric second expansion valve 338 is provided partway along the pipe 316. One end of a pipe 318 is connected to a heat exchange medium outflow side of the evaporator 340, and another end of the pipe 318 is connected to both one end of the pipe 304 and another end of the pipe 312. A pressure regulation valve 342 is provided partway along the pipe 318.

The cooling water circulation path 350 includes a pipe 352. A water pump 362 and the vehicle engine 364 are provided along the pipe 352, in sequence from the upstream side in the cooling water circulation direction. Cooling water flowing through the pipe 352 passes through the inside of a water jacket of the engine 364, receiving heat from the engine 364 and thus cooling the engine 364.

One end of the pipe 352 is connected both one end of a pipe 354 and one end of a pipe 356, and another end of the pipe 352 is connected to both one end of a pipe 358 and one end of a pipe 360. Another end of the pipe 354 is connected to a cooling water inflow side of the radiator 366, and another end of the pipe 358 is connected to a cooling water outflow side of the radiator 366. A mechanical thermostat 368 is provided partway along the pipe 358.

Further, another end of the pipe 356 is connected to a cooling water inflow side of a heater core 370 and cooling water that has flowed into the pipe 356 flows into the heater core 370. Further, another end of the pipe 360 is connected to a cooling water outflow side of the heater core 370.

The arrows X in FIG. 17 illustrate an example of a circulation path of cooling medium in the heat exchange medium circulation path 302, and the arrows Y in FIG. 17 illustrate an example of a circulation path of cooling water in the cooling water circulation path 350, in cases in which the vehicle cabin interior is dehumidified and heated by the air-conditioning device of the vehicle heat management system 300. The vehicle heat management system 300 is able to connect the exterior heat exchanger 330 and the evaporator 340 to each other either in series or in parallel when dehumidification and heating of the vehicle cabin interior is being performed. The connection type is selected according to the ambient air temperature or the like. The arrows X in FIG. 17 illustrate a circulation path of cooling medium in cases in which the second solenoid valve 332 and the third solenoid valve 334 are closed, and the exterior heat exchanger 330 and the evaporator 340 are connected in series.

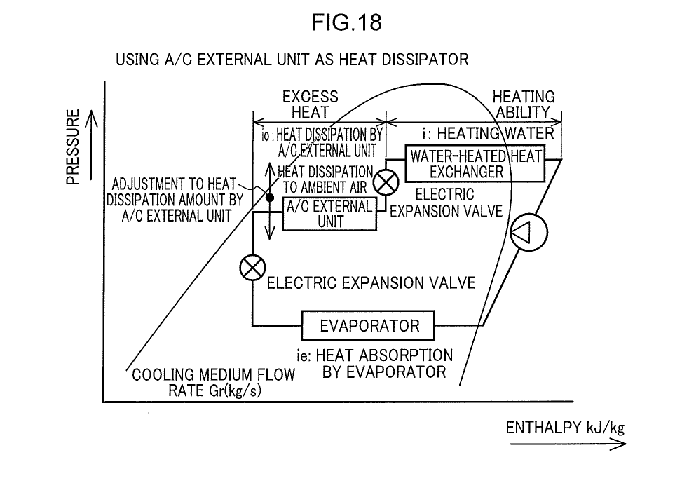

The vehicle heat management system 300 according to the comparative example controls the degree of excess cooling in the cooling medium using the electric first expansion valve 326, and controls the evaporation pressure in the exterior heat exchanger 330 using the electric second expansion valve 338. Thus, in cases in which the heating demand is low, heat is dissipated by the exterior heat exchanger 330 as illustrated in FIG. 18, and in cases in which the heating demand is high, action of the exterior heat exchanger 330 can be switched such that the exterior heat exchanger 330 absorbs heat. However, in the vehicle heat management system 300 according to the comparative example, an issue arises in that the first expansion valve 326 and the second expansion valve 338 must each be configured by an expensive electric expansion valve, increasing costs.

Further, the accumulator tank 320 is also necessary, since the vehicle heat management system 300 according to the comparative example controls the flow rate of the cooling medium passing through the evaporator 340 using the accumulator tank 320. A further issue arises in that the size of the accumulator tank 320 is large, with a diameter of about 90 mm and a height of about 200 mm, for example, and thus a large space is needed in order to install the vehicle heat management system 300 according to the comparative example.

### First Exemplary Embodiment

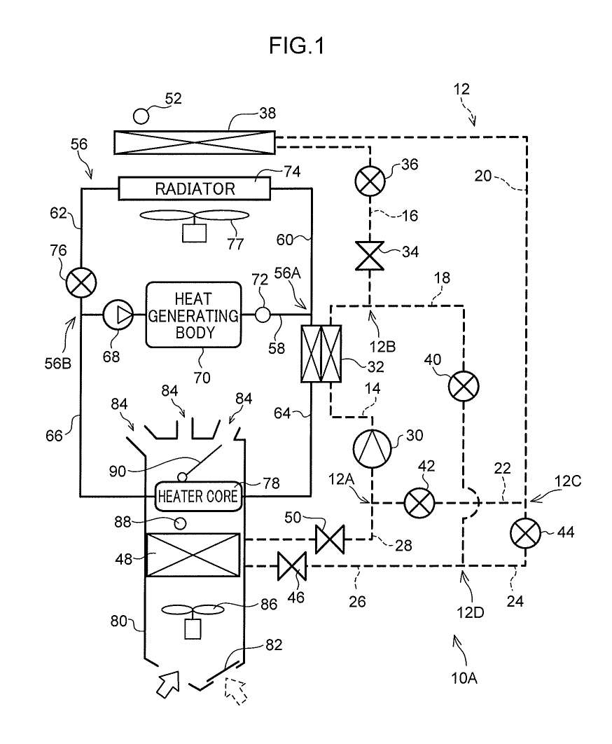

FIG. 1 illustrates a vehicle heat management system 10A according to a first exemplary embodiment. The vehicle heat management system 10A includes an air-conditioning device that circulates a first heat exchange medium in a first circulation path 12 to air-condition a vehicle cabin interior, and a cooling water management device that circulates cooling water in a second circulation path 56 to cool a heat generating body 70 of a vehicle. Note that in FIG. 1, the first circulation path 12 is illustrated by dashed lines, and the second circulation path 56 is illustrated by solid lines. In the present exemplary embodiment, the cooling water is an example of a second heat exchange medium of the present description, and the second heat exchange medium may be a medium other than cooling water.

First, explanation follows regarding the first circulation path 12. The first circulation path 12 includes a compressor 30 that compresses a first heat exchange medium in the first circulation path 12. The compressor 30 is provided partway along a pipe 14, with one end of the compressor 30 positioned at a connection point 12A, and another end of the compressor 30 positioned at a connection point 12B of the first circulation path 12. Along the pipe 14, a first heat exchanger 32 is provided at a position corresponding to a downstream side of the compressor 30 so as to be capable of performing heat exchange between a primary side and a secondary side. The first heat exchange medium discharged from the compressor 30 passes through the primary side of the first heat exchanger 32. Note that the first heat exchanger 32 is an example of a first heat exchanger of the present description, and the compressor 30 is an example of a first circulator section of the present description.

At the connection point 12B of the first circulation path 12, the other end of the pipe 14 is connected to both one end of a pipe 16 and one end of a pipe 18. The first heat exchange medium that has passed through the primary side of the first heat exchanger 32 and reached the connection point 12B branches into first heat exchange medium that flows into the pipe 16 and first heat exchange medium that flows into the pipe 18.

Another end of the pipe 16 is connected to a heat-exchange-medium inflow side of an exterior heat exchanger 38, and a first expansion valve 34 and a first solenoid valve 36 are provided in sequence along the pipe 16. The exterior heat exchanger 38 is disposed at a vehicle front side of a radiator 74, described later, and an ambient air temperature sensor 52 is disposed at the vehicle front side of the exterior heat exchanger 38. Further, one end of a pipe 20 is connected to a heat-exchange-medium outflow side of the exterior heat exchanger 38, and at a connection point 12C of the first circulation path 12, another end of the pipe 20 is connected to both one end of a pipe 22 and one end of a pipe 24. Another end of the pipe 22 is positioned at the connection point 12A, and a third solenoid valve 42 is provided partway along the pipe 22.

On the other hand, another end of the pipe 18 is connected to both another end of the pipe 24 and one end of a pipe 26 at a connection point 12D. A second solenoid valve 40 is provided partway along the pipe 18, and a fourth solenoid valve 44 is provided partway along the pipe 24. Another end of the pipe 26 is connected to a heat-exchange-medium inflow side of an evaporator 48, and a second expansion valve 46 is provided partway along the pipe 26. One end of a pipe 28 is connected to a heat-exchange-medium outflow side of the evaporator 48, and at the connection point 12A, another end of the pipe 28 is connected to both the one end of the pipe 14 and to another end of the pipe 22. A pressure regulation valve 50 is provided partway along the pipe 28.

Note that the evaporator 48 is an example of a heat absorption section of the present description. As described above, in the first circulation path 12, the pipes 16, 20, and 22 and the pipes 18, 26, 28 are connected, in parallel, to the pipe 14. The pipe 14 is an example of a first flow path, the pipes 16, 20, and 22 are an example of a second flow path, and the pipes 18, 26, and 28 are an example of a third flow path.

Further, the evaporator 48 is disposed in a heating, ventilation, and air-conditioning (HVAC) unit 80. The HVAC unit 80 is provided with a first air intake port that draws in air (interior air) from the vehicle cabin interior, and a second air intake port that draws in air (ambient air) from the vehicle cabin exterior, and the HVAC unit 80 is also provided with an interior/ambient air switching door 82 that is capable of moving between positions that close either the first air intake port or the second air intake port. The HVAC unit 80 is provided with plural vents 84 that open to the vehicle cabin interior on an exhaust side on the opposite side to the interior/ambient air switching door 82. In the HVAC unit 80, a blower 86 is provided between the interior/ambient air switching door 82 and the evaporator 48. The blower 86 generates airflow by drawing in air through the first air intake port or the second air intake port and blowing the air out through the vents 84.

An air temperature sensor 88, a heater core 78, and an air-mixing door 90 are provided in sequence between the evaporator 48 and the plural vents 84. The air temperature sensor 88 detects a temperature Te of air passing through the evaporator 48. The heater core 78 is connected to the second circulation path 56, and dissipates heat by passing cooling water through the inside of the heater core 78. The heater core 78 of the present exemplary embodiment is an example of a heat dissipating section of the present description. The air-mixing door 90 is capable of moving between a heating position that guides air heated by the heater core 78 toward the vents 84, and a non-heating position that isolates air heated by the heater core 78.

Next, explanation follows regarding the second circulation path 56. The second circulation path 56 includes a pipe 58. One end of the pipe 58 is positioned at a connection point 56A, and another end of the pipe 58 is positioned at a connection point 56B. A water pump 68 (referred to as “WP” below), this being an example of a second circulator section, and a heat generating body 70 of the vehicle and a water temperature sensor 72 are provided along the pipe 58, in sequence from the connection point 56B side. One example of the heat generating body 70 is a vehicle engine; however, the heat generating body is not limited thereto. The heat generating body may be any of a motor, a battery, an inverter, a transmission, or a fuel cell stack of a fuel cell vehicle, for example. The WP 68 may be a mechanical WP that acts using an engine as a drive source, or may be an electric WP that acts using a motor as a drive source. In the present exemplary embodiment, explanation is given regarding an embodiment in which an electric WP is applied as the WP 68 of the present exemplary embodiment. The cooling water flowing through the pipe 58 receives heat from the heat generating body 70, thereby cooling the heat generating body 70. Note that the pipe 58 is an example of a fourth flow path.

Both one end of a pipe 60 and one end of a pipe 64 are positioned at the connection point 56A, and at the connection point 56A, one end of the pipe 58 is connected to both the one end of the pipe 60 and the one end of the pipe 64. Further, both one end of a pipe 62 and one end of a pipe 66 are positioned at the connection point 56B, and at the connection point 56B, the other end of the pipe 58 is connected to both the one end of the pipe 62 and the one end of the pipe 66. Another end of the pipe 60 is connected to a cooling water inflow side of the radiator 74, and another end of the pipe 62 is connected to a cooling water outflow side of the radiator 74. A flow rate regulating valve 76 is provided partway along the pipe 62. Further, an electric fan 77 that generates airflow that flows from the exterior heat exchanger 38 side to the radiator 74 side is provided at the opposite side of the radiator 74 to the exterior heat exchanger 38. The pipes 60, 62 are an example of a fifth flow path, and the flow rate regulating valve 76 is an example of a first flow rate regulating section and a flow rate regulating valve.

Further, another end of the pipe 64 is connected to a cooling water inflow side of the heater core 78, and the first heat exchanger 32 is provided partway along the pipe 64. The cooling water that has flowed from the connection point 56A into the pipe 64 flows into the heater core 78 via the secondary side of the first heat exchanger 32. Further, another end of the pipe 66 is connected to a cooling water outflow side of the heater core 78. The pipes 64, 66 are an example of a sixth flow path.

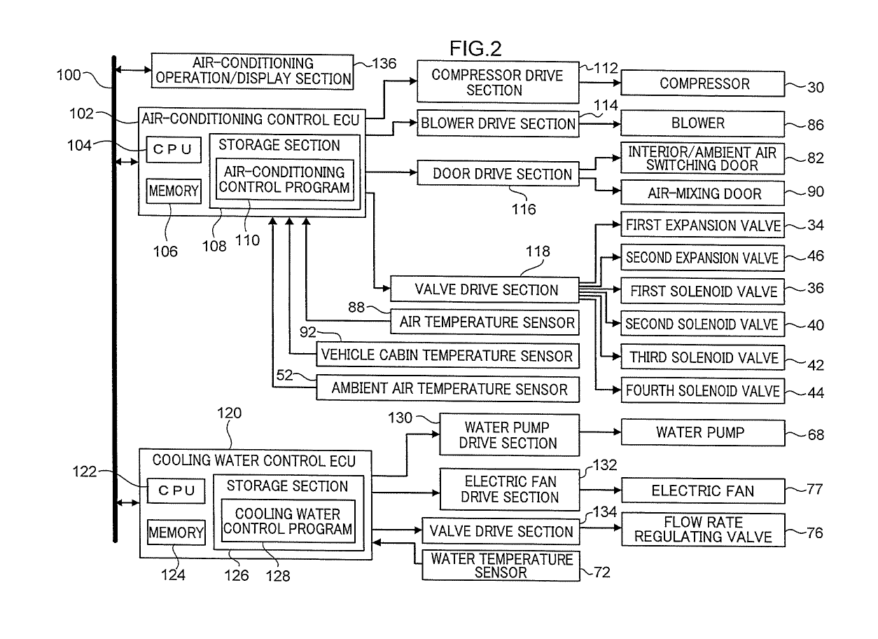

FIG. 2 illustrates a section related to a vehicle heat management system of a vehicle onboard system installed in the vehicle. The vehicle onboard system includes a bus 100, and plural Electronic Control Units and various devices are respectively connected to the bus 100. Each Electronic Control Unit (ECU) is a control unit that includes a CPU, memory, and a non-volatile storage section, and is referred to as an ECU below. Out of the plural ECUs, FIG. 2 illustrates an air-conditioning control ECU 102 configuring part of the air-conditioning device, and a cooling water control ECU 120 configuring part of the cooling water management device. Further, out of the various devices, FIG. 2 illustrates an air-conditioning operation/display section 136 with which an occupant checks the air-conditioning status and inputs instructions to the air-conditioning device.

The air-conditioning operation/display section 136 includes a switch for turning actuation of the air-conditioning device ON or OFF, a ten-key for setting a vehicle cabin interior target temperature, and buttons (for example, a button labelled “A/C”) used to instruct dehumidifying and the like. The air-conditioning operation/display section 136 includes a switch for switching between an ambient air introducing mode and an internal air circulation mode.

The air-conditioning control ECU 102 includes a CPU 104, memory 106, and a non-volatile storage section 108 that stores an air-conditioning control program 110. The air-conditioning control ECU 102 performs air-conditioning control processing that includes dehumidifying-heating operation processing, described later, by reading the air-conditioning control program 110 from the storage section 108, expanding the air-conditioning control program 110 in the memory 106, and executing the air-conditioning control program 110 expanded in the memory 106 using the CPU 104.

The air-conditioning control ECU 102 is connected to a compressor drive section 112, a blower drive section 114, a door drive section 116, a valve drive section 118, an air temperature sensor 88, a vehicle cabin temperature sensor 92, and an ambient air temperature sensor 52. The compressor drive section 112 drives the compressor 30 under instruction from the air-conditioning control ECU 102. The blower drive section 114 drives the blower 86 under instruction from the air-conditioning control ECU 102. The door drive section 116 switches the position of the interior/ambient air switching door 82 and the position of the air-mixing door 90 under instruction from the air-conditioning control ECU 102.

The valve drive section 118 opens and closes the first expansion valve 34, the second expansion valve 46, the first solenoid valve 36, the second solenoid valve 40, the third solenoid valve 42, and the fourth solenoid valve 44 under instruction from the air-conditioning control ECU 102. The air temperature sensor 88 detects the temperature Te of air that has passed through the evaporator 48, and outputs the detection results to the air-conditioning control ECU 102. The vehicle cabin temperature sensor 92 detects a temperature Troom of the vehicle cabin interior, and outputs the detection results to the air-conditioning control ECU 102. The ambient air temperature sensor 52 detects an ambient air temperature Tamb, and outputs the detection results to the air-conditioning control ECU 102.

The cooling water control ECU 120 includes a CPU 122, memory 124, and a non-volatile storage section 126 that stores a cooling water control program 128. The cooling water control ECU 120 performs cooling water control processing by reading the cooling water control program 128 from the storage section 126, expanding the cooling water control program 128 in the memory 124, and executing the cooling water control program 128 expanded in the memory 124 using the CPU 122.

By performing the cooling water control processing, the cooling water control ECU 120 together with the air-conditioning control ECU 102 that performs the air-conditioning control processing functions as an example of a first control section of the present description. Further, the air-conditioning control ECU 102 also functions as an example of a second control section of the present description. The compressor 30 together with the WP 68 and the flow rate regulating valve 76 functions as a vehicle heat management device according to the present description. Further, the air-conditioning control ECU 102, the cooling water control ECU 120, a valve drive section 134, and the flow rate regulating valve 76 of the first exemplary embodiment are an example of a flow rate change section of the present description.

The cooling water control ECU 120 is connected to a WP drive section 130, an electric fan drive section 132, a valve drive section 134, and the water temperature sensor 72. The WP drive section 130 drives the WP 68 under instruction from the cooling water control ECU 120, and the electric fan drive section 132 drives the electric fan 77 under instruction from the cooling water control ECU 120. The valve drive section 134 changes the opening amount of the flow rate regulating valve 76 under instruction from the cooling water control ECU 120. The water temperature sensor 72 detects a water temperature Tw of the cooling water in the pipe 58 (in the fourth flow path), and outputs the detection results to the cooling water control ECU 120.

Next, regarding operation of the first exemplary embodiment, first, explanation follows regarding action of the cooling water management device.

Action of the Cooling Water Management Device when Warming Up the Heat Generating Body

In cases in which, for example, the heat generating body 70 is a vehicle engine, when the heat generating body 70 is started up and the cooling water temperature detected by the water temperature sensor 72 is less than a predetermined temperature, the heat generating body 70 is warmed up. When this is performed, the cooling water control ECU 120 closes the flow rate regulating valve 76 using the valve drive section 134, and drives the WP 68 using the WP drive section 130.

The driven WP 68 draws in cooling water at the upstream side of the pipe 58 and pumps out the cooling water toward the downstream side of the pipe 58. In cases in which the flow rate regulating valve 76 is closed, the cooling water pumped out by the WP 68 flows in sequence through the connection point 56A, the pipe 64, the connection point 56B, the pipe 58, and the connection point 56A. In this manner, the flow rate regulating valve 76 is closed and the cooling water does not flow through the radiator 74 during warm-up of the heat generating body 70. Thus, the cooling water temperature rises to the predetermined temperature or greater in a short period of time due to waste heat from the heat generating body 70, such that warm-up of the heat generating body 70 completes in a short period of time.

Note that during warm-up of the heat generating body 70, the air-conditioning control ECU 102 may drive the compressor 30 so as to circulate the first heat exchange medium in the first circulation path 12. This causes heat transfer from the primary side to the secondary side of the first heat exchanger 32, thereby further shortening the warm-up time of the heat generating body 70.

Action of the Cooling Water Management Device after Engine Warm-Up

When the operation of the heat generating body 70 continues and the cooling water temperature detected by the water temperature sensor 72 becomes the predetermined temperature or greater, the cooling water control ECU 120 transitions to normal control. Namely, the cooling water control ECU 120 uses the valve drive section 134 to control the opening amount of the flow rate regulating valve 76 according to deviation of the cooling water temperature from a target water temperature, and drives the WP 68 using the WP drive section 130. Thus, the cooling water flows through the radiator 74, and the cooling water that was raised in temperature by waste heat from the heat generating body 70 is cooled by the radiator 74. Further, in cases in which in which the cooling water temperature exceeds a threshold temperature value, the cooling water control ECU 120 rotates the electric fan 77 to increase the rate of airflow passing through the radiator 74 so as to increase the amount of heat dissipation from the radiator 74.

Next, explanation follows regarding action of the air-conditioning device.

Heating Operation by the Air-Conditioning Device

When an instruction to heat the vehicle cabin interior has been given by a vehicle occupant via the air-conditioning operation/display section 136, the air-conditioning control ECU 102 sets the first expansion valve 34 to a predetermined opening amount using the valve drive section 118 in order to reduce the pressure of the first heat exchange medium. Further, the air-conditioning control ECU 102 uses the valve drive section 118 to open the first solenoid valve 36 and the third solenoid valve 42, and to close the second solenoid valve 40 and the fourth solenoid valve 44. Further, the air-conditioning control ECU 102 uses the door drive section 116 to switch the position of the interior/ambient air switching door 82 according to the air-conditioning mode that was instructed using the air-conditioning operation/display section 136 and to switch the air-mixing door 90 to the heating position, and uses the blower drive section 114 to drive the blower 86. The air-conditioning control ECU 102 uses the compressor drive section 112 to drive the compressor 30 at a revolution speed according to a deviation ΔT1 of the vehicle cabin interior temperature Troom detected by the vehicle cabin temperature sensor 92 with respect to a vehicle cabin interior target temperature Tref that was set using the air-conditioning operation/display section 136.

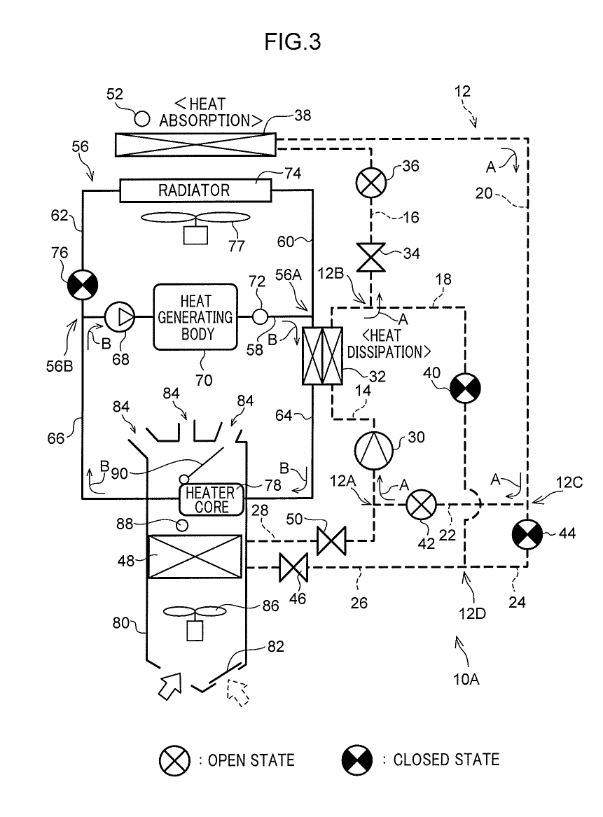

Thus, the first heat exchange medium circulates in the first circulation path 12 along the path illustrated by arrows A in FIG. 3. Namely, the compressor 30 draws in and compresses the first heat exchange medium, and the high pressure compressed first heat exchange medium becomes liquid (see “heat dissipation” in FIG. 3) while dissipating heat as it passes through the first heat exchanger 32 (heating cooling water on the secondary side in the first heat exchanger 32). Further, the second solenoid valve 40 is closed, and so the first heat exchange medium that has passed through the first heat exchanger 32 flows from the connection point 12B into the pipe 16, is reduced in pressure using the first expansion valve 34, and is supplied to the exterior heat exchanger 38 in a low pressure state.

The first heat exchange medium supplied to the exterior heat exchanger 38 evaporates while passing through the exterior heat exchanger 38, thereby absorbing heat from air in the proximity of the exterior heat exchanger 38 (see “heat absorption” in FIG. 3). The fourth solenoid valve 44 is closed, and so the first heat exchange medium that has passed through the exterior heat exchanger 38 and flowed into the pipe 20 flows from the connection point 12C into the pipe 22, and is drawn into the compressor 30 again via the pipes 22, 14.

Further, in the heating action, the air-conditioning control ECU 102 instructs the cooling water control ECU 120 to close the flow rate regulating valve 76, and the cooling water control ECU 120 thus closes the flow rate regulating valve 76 using the valve drive section 134. Accordingly, cooling water circulates in the second circulation path 56 along the path illustrated by arrows B in FIG. 3.

Namely, the cooling water discharged from the WP 68 flows from the connection point 56A into the pipe 64, and is heated while passing through the secondary side of the first heat exchanger 32. The cooling water that has passed through the first heat exchanger 32 heats air in the proximity of the heater core 78 inside the HVAC unit 80 while passing through the heater core 78. When this is performed, the air-mixing door 90 is positioned at the heating position and the blower 86 is being driven, such that the vehicle cabin interior is heated as a result of the heated air being supplied through the vents 84 into the vehicle cabin interior.

Note that when the heating demand changes due to a change in the deviation ΔT1 of the vehicle cabin interior temperature Troom with respect to the vehicle cabin interior target temperature Tref, the air-conditioning control ECU 102 changes the revolution speed of the compressor 30 according to the changed heating demand and changes the amount of heat transfer in the first heat exchanger 32. On the other hand, the air-conditioning control ECU 102 does not instruct the cooling water control ECU 120 to open the flow rate regulating valve 76 even if the heating demand changes. Thus, the flow rate of the cooling water inside the radiator 74 is kept at 0 in the heating action.

Cooling Operation by the Air-Conditioning Device

When an instruction to cool the vehicle cabin interior has been given by a vehicle occupant via the air-conditioning operation/display section 136, the air-conditioning control ECU 102 uses the valve drive section 118 to fully open the first expansion valve 34, opens the first solenoid valve 36 and the fourth solenoid valve 44, and closes the second solenoid valve 40 and the third solenoid valve 42.

Further, the air-conditioning control ECU 102 uses the door drive section 116 to switch the position of the interior/ambient air switching door 82 according to the air-conditioning mode instructed using the air-conditioning operation/display section 136 and to switch the air-mixing door 90 to the non-heating position, and uses the blower drive section 114 to drive the blower 86. The air-conditioning control ECU 102 uses the compressor drive section 112 to drive the compressor 30 at a revolution speed according to a deviation ΔT1 of the vehicle cabin interior temperature Troom detected by the vehicle cabin temperature sensor 92 from the vehicle cabin interior target temperature Tref that was set using the air-conditioning operation/display section 136.

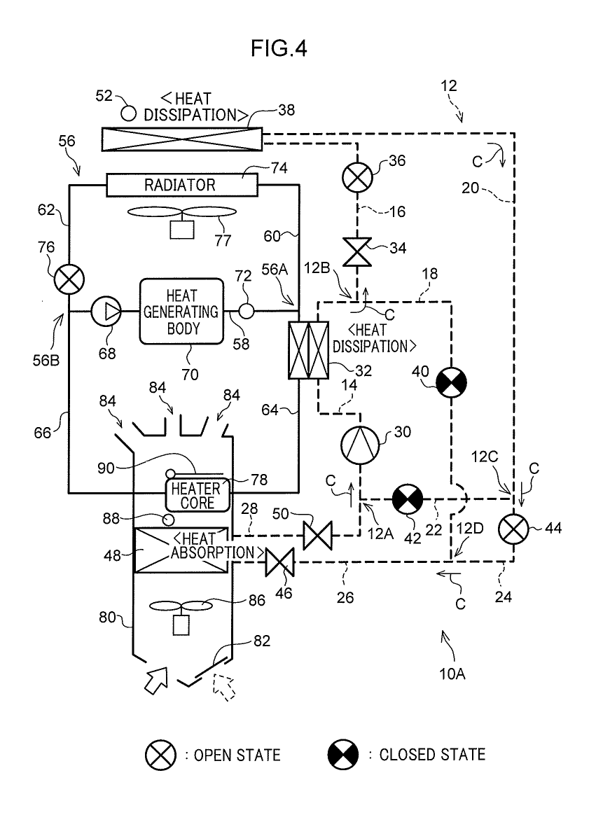

The first heat exchange medium accordingly circulates in the first circulation path 12 along the path illustrated by arrows C in FIG. 4. Namely, the compressor 30 draws in and compresses the first heat exchange medium, and the high pressure compressed heat exchange medium dissipates heat (heating the cooling water on the secondary side in the first heat exchanger 32) while passing through the first heat exchanger 32 (see “heat dissipation” in FIG. 4). Further, the second solenoid valve 40 is closed, and so the first heat exchange medium that has passed through the first heat exchanger 32 flows from the connection point 12B into the pipe 16, passes through the fully opened first expansion valve 34, and is supplied to the exterior heat exchanger 38 while still at high pressure.

The first heat exchange medium supplied to the exterior heat exchanger 38 becomes liquid while dissipating heat as it passes through the exterior heat exchanger 38 (see “heat dissipation” in FIG. 4). Further, the third solenoid valve 42 is closed, and so the first heat exchange medium that has passed through the first heat exchanger 32 flows from the connection point 12C into the pipe 24, and, since the second solenoid valve 40 is closed, flows from the connection point 12D into the pipe 26. The pressure of the first heat exchange medium that has flowed into the pipe 26 is reduced to a low pressure by the second expansion valve 46, and the first heat exchange medium evaporates while passing through the evaporator 48 and cools the air in the proximity of the evaporator 48 (see “heat absorption” in FIG. 4).

When this is performed, the air-mixing door 90 is positioned at the non-heating position and the blower 86 is being driven, such that the cooled air is supplied to the vehicle cabin interior through the vents 84 without being heated by the heater core 78, thus cooling the vehicle cabin interior. The first heat exchange medium that has passed through the evaporator 48 is then drawn into the compressor 30 again.

Note that when the cooling demand changes due to a change in the deviation ΔT1 of the vehicle cabin interior temperature Troom from the vehicle cabin interior target temperature Tref, the air-conditioning control ECU 102 changes the revolution speed of the compressor 30 according to the changed cooling demand and changes the amount of cooling by the evaporator 48.

Dehumidifying-heating Operation by the Air-Conditioning Device

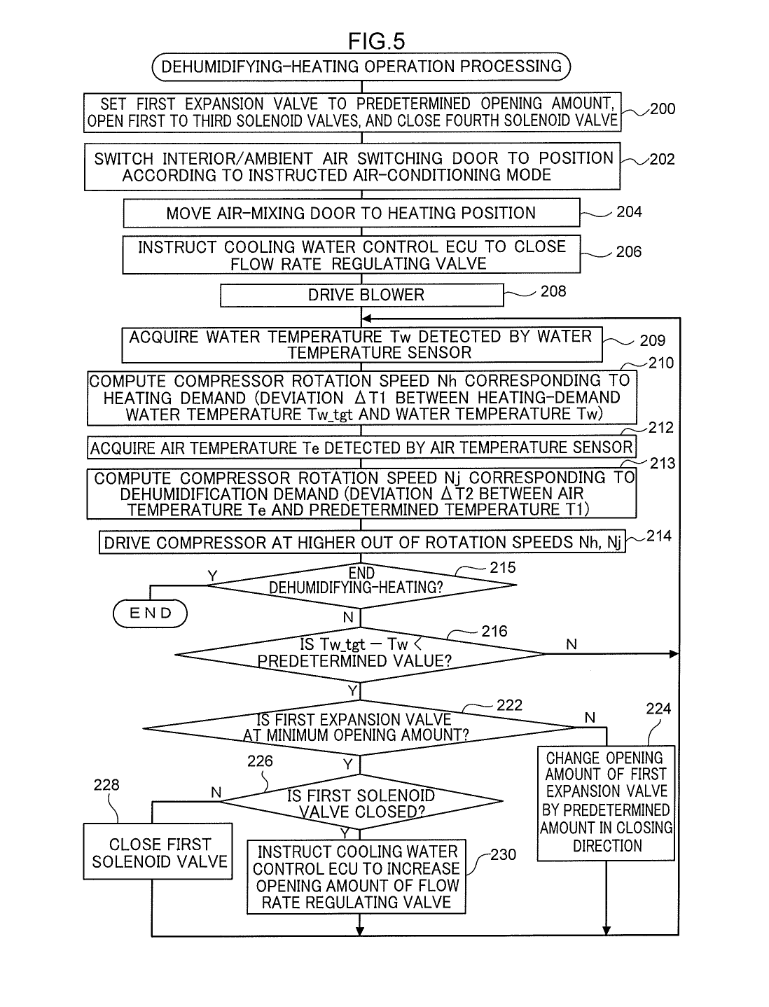

When an instruction to dehumidify and heat the vehicle cabin interior has been given by the vehicle occupant via the air-conditioning operation/display section 136, the air-conditioning control ECU 102 performs the dehumidifying-heating operation processing illustrated in FIG. 5.

Namely, at step 200 of the dehumidifying-heating operation processing, the air-conditioning control ECU 102 sets the first expansion valve 34 to a predetermined opening amount using the valve drive section 118 in order to reduce the pressure of the first heat exchange medium. Further, the air-conditioning control ECU 102 uses the valve drive section 118 to open the first solenoid valve 36, the second solenoid valve 40, and the third solenoid valve 42, and to close the fourth solenoid valve 44. At step 202, the air-conditioning control ECU 102 uses the door drive section 116 to switch the position of the interior/ambient air switching door 82 according to the air-conditioning mode instructed via the air-conditioning operation/display section 136. Further, at step 204, the air-conditioning control ECU 102 uses the door drive section 116 to switch the air-mixing door 90 to the heating position.

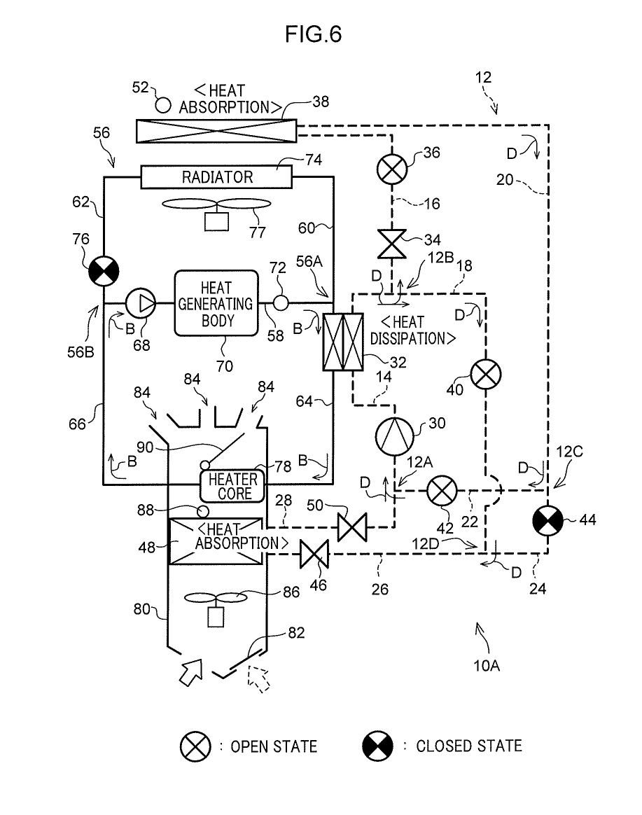

At the next step 206, the air-conditioning control ECU 102 instructs the cooling water control ECU 120 to close the flow rate regulating valve 76. The cooling water control ECU 120 accordingly closes the flow rate regulating valve 76 using the valve drive section 134, and cooling water circulates in the second circulation path 56 along the path illustrated by arrows B in FIG. 6. Note that step 206 may be omitted since it is not necessary for the flow rate regulating valve 76 to be closed at an early stage during the dehumidifying-heating operation (a stage before warming demand decreases). However, closing the flow rate regulating valve 76 increases the amount of heat dissipated by the heater core 78, thereby improving heating performance. At the next step 208, the air-conditioning control ECU 102 uses the blower drive section 114 to drive the blower 86.

At step 209, the air-conditioning control ECU 102 acquires the water temperature Tw that was detected by the water temperature sensor 72 from the water temperature sensor 72. At step 210, the air-conditioning control ECU 102 sets the deviation ΔT1 of the water temperature Tw subtracted from a heating-demand water temperature Tw_tgt, this being a target water temperature, as the heating demand, and computes a revolution speed Nh of the compressor 30 according to this heating demand (deviation ΔT1=Tw_tgt−Tw).

At step 212, the air-conditioning control ECU 102 acquires the air temperature Te that was detected by the air temperature sensor 88 from the air temperature sensor 88. At step 213, the air-conditioning control ECU 102 sets a deviation ΔT2 of a predetermined temperature T1 (for example, 0° C.) subtracted from the air temperature Te as the dehumidification demand, and computes a revolution speed Nj of the compressor 30 corresponding to this dehumidification demand (deviation ΔT2=Te−T1).

At the next step 214, the air-conditioning control ECU 102 selects the higher out of the revolution speed Nh of the compressor 30, computed at step 210 and corresponding to the heating demand, and the revolution speed Nj of the compressor 30, computed at step 213 and corresponding to the dehumidification demand. Then, the air-conditioning control ECU 102 uses the compressor drive section 112 to drive the compressor 30 at the higher revolution speed out of the revolution speeds Nh, Nj.

At step 215, the air-conditioning control ECU 102 determines whether or not an instruction has been given by the vehicle occupant via the air-conditioning operation/display section 136 to end the dehumidifying-heating operation in the vehicle cabin interior. In cases in which determination at step 215 is affirmative, the dehumidifying-heating operation processing is ended. On the other hand, processing transitions to step 216 in cases in which determination at step 215 is negative, and at step 216, the air-conditioning control ECU 102 determines whether or not the heating demand (deviation ΔT1=Tw_tgt−Tw) has been decreased to less than a predetermined value.

In cases in which the air-conditioning mode is an ambient air introducing mode, the dehumidification demand is normally constant, whereas in cases in which the air-conditioning mode is an internal air circulation mode, the dehumidification demand tends to increase when the vehicle cabin interior temperature Troom rises. Thus, the determination at step 216 is an example of determination as to whether or not “from a first state, heat dissipation demand has decreased relative to heat absorption demand” of the present description. Instead of determining a decrease in the heating demand (deviation ΔT1), this determination may be implemented by determination that compares the rate of change in the heating demand (deviation ΔT1) or the like against the rate of change of the dehumidification demand (deviation ΔT2) or the like.

In cases in which determination is negative at step 216, processing returns to step 209, and step 209 to step 216 are repeated until determination at either step 215 or step 216 is affirmative. Thus, the first heat exchange medium circulates in the first circulation path 12 along the path illustrated by arrows D in FIG. 6 during an initial stage of the dehumidifying-heating operation (the stage before the heating demand decreases). Namely, the compressor 30 draws in and compresses the first heat exchange medium, and the high pressure compressed first heat exchange medium becomes a liquid while dissipating heat (heating the cooling water on the secondary side in the first heat exchanger 32) as it passes through the first heat exchanger 32 (see “heat dissipation” in FIG. 6). Further, the first heat exchange medium that has passed through the first heat exchanger 32 branches and flows from the connection point 12B into the pipes 16, 18.

The first heat exchange medium that has flowed into the pipe 16 is decreased in pressure by the first expansion valve 34 and supplied to the exterior heat exchanger 38 in a low pressure state. The first heat exchange medium that has been supplied to the exterior heat exchanger 38 evaporates and absorbs heat from air in the proximity of the exterior heat exchanger 38 while passing through the exterior heat exchanger 38 (see “heat absorption” in FIG. 6). The fourth solenoid valve 44 is closed, and so the first heat exchange medium that has passed through the exterior heat exchanger 38 and flowed into the pipe 20 flows from the connection point 12C into the pipe 22 and is drawn into the compressor 30 again via the pipes, 22, 14.

Further, the first heat exchange medium that has flowed into the pipe 18 flows from the connection point 12D into the pipe 26, and is decreased to a lower pressure by the second expansion valve 46. Then, the first heat exchange medium evaporates and cools the air in the proximity of the evaporator 48 while passing through the evaporator 48 (see “heat absorption” in FIG. 6) such that the air in the proximity of the evaporator 48 is dehumidified. The first heat exchange medium that has passed through the evaporator 48 merges with the first heat exchange medium that has flowed through the pipe 22 at connection point 12A, and is drawn into the compressor 30 again.

During dehumidifying-heating operation, the air-mixing door 90 is positioned at the heating position and the blower 86 is being driven, such that air cooled and dehumidified by the evaporator 48 is heated by the heater core 78 and supplied to the vehicle cabin interior through the vents 84. Thus, in the early stage of dehumidifying-heating operation (the stage before the heating demand decreases), dehumidifying-heating operation is performed in the operation state illustrated in FIG. 6.

Note that particularly in cases in which the dehumidifying-heating is performed in the internal air circulation mode, when the vehicle cabin interior temperature Troom rises such that the amount of saturated water vapor increases, the moisture content within the air in the vehicle cabin interior increases as a result of water vapor contained in the breath of the occupants, sweat from the occupants, evaporation of condensation on the windows, and so on. Thus, when the vehicle cabin temperature Troom rises as time passes since starting the dehumidifying-heating in the internal air circulation mode, the heating demand tends to decrease, while the dehumidification demand tends to increase.

When the heating demand (deviation ΔT1) becomes small relative to the dehumidification demand (deviation ΔT2), determination at step 216 is affirmative and processing transitions to step 222. Note that here, the dehumidification demand does not decrease, and so the revolution speed of the compressor 30 cannot be decreased in accordance with the decrease in the heating demand. Thus, at step 222, the air-conditioning control ECU 102 determines whether or not the first expansion valve 34 is opened to a minimum amount. In cases in which determination at step 222 is negative, processing transitions to step 224. At step 224, the air-conditioning control ECU 102 uses the valve drive section 118 to change the opening amount of the first expansion valve 34 by a predetermined amount in the closing direction, and processing returns to step 209.

Thus, the amount of heat absorption in the exterior heat exchanger 38 decreases due to the flow rate of the first heat exchange medium passing through the exterior heat exchanger 38 decreasing. In the first circulation path 12, the amount of heat transferred from the first heat exchange medium to the cooling water in the first heat exchanger 32 is the sum total of the amount of heat absorbed in the exterior heat exchanger 38, the amount of heat absorbed in the evaporator 48, and the work done by the compressor 30.

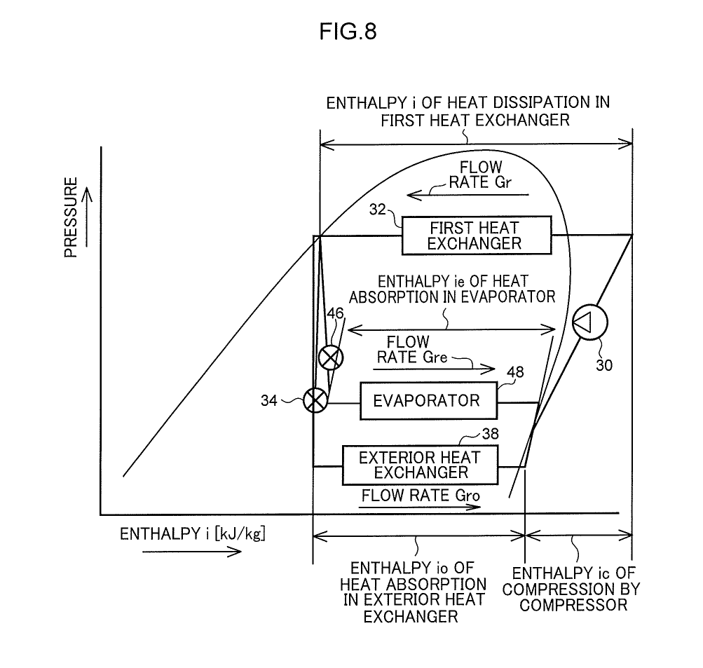

As illustrated in FIG. 8, for example, let Gr [kg/s] denote the flow rate of the first heat exchange medium in the first heat exchanger 32 and i [kJ/kg] denote the enthalpy of heat transfer (heat dissipation) in the first heat exchanger 32. Further, let Gro [kg/s] denote the flow rate of the first heat exchange medium in the exterior heat exchanger 38, and io [kJ/kg] denote the enthalpy of heat absorption in the exterior heat exchanger 38. Further, let Gre [kg/s] denote the flow rate of the first heat exchange medium in the evaporator 48, ie [kJ/kg] denote the enthalpy of heat absorption in the evaporator 48, and is [kJ/kg] denote the enthalpy of compression of the first heat exchange medium by the compressor 30. Then Equation (1) given below is satisfied. Note that the flow rate of the first heat exchange medium in the compressor 30 is equal to the flow rate Gr of the first heat exchange medium in the first heat exchanger 32.

Gr·i=Gro·io+Gre·ie+Gr˜ie (1)

Accordingly, the flow rate Gro of the first heat exchange medium in the exterior heat exchanger 38 decreases, such that the left-hand side of Equation (1), namely, the amount of heat transfer from the first heat exchange medium to the cooling water in the first heat exchanger 32 decreases, enabling the amount of heat dissipated by the heater core 78 to be decreased.

Further, each time determination is negative at step 222, the opening amount of the first expansion valve 34 is changed at step 224 such that the flow rate Gro of the first heat exchange medium in the exterior heat exchanger 38 gradually decreases. However, in cases in which the heating demand continues to decrease despite the first expansion valve 34 having reached the minimum opening amount, determination at step 222 is affirmative and processing transitions to step 226.

At step 226, the air-conditioning control ECU 102 determines whether or not the first solenoid valve 36 is closed. In cases in which determination at step 226 is negative, processing transitions to step 228. At step 228, the air-conditioning control ECU 102 uses the valve drive section 118 to close the first solenoid valve 36. The flow rate Gro of the first heat exchange medium in the exterior heat exchanger 38 thus becomes 0, and the first term on the right-hand side of Equation (1), namely the amount of heat absorption in the exterior heat exchanger 38, becomes 0. Processing returns to step 209 after the processing of step 228.

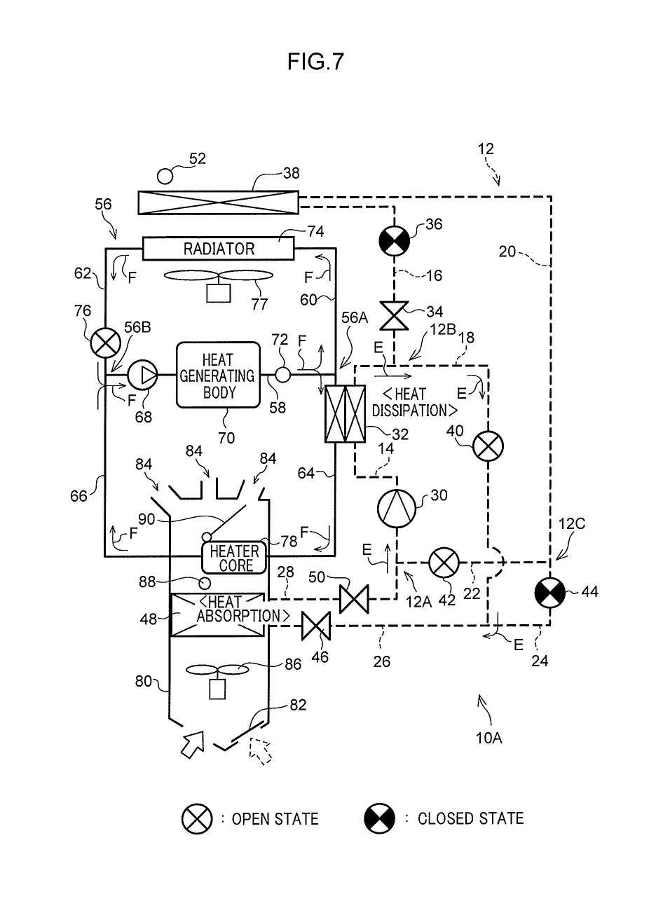

Thus, during the late stage of the dehumidifying-heating operation after the heating demand has decreased, the first heat exchange medium circulates in the first circulation path 12 along the path illustrated by arrows E in FIG. 7. Namely, the compressor 30 draws in and compresses the first heat exchange medium, and the high pressure compressed first heat exchange medium becomes liquid while dissipating heat (heating the cooling water on the secondary side in the first heat exchanger 32) as it passes through the first heat exchanger 32 (see “heat dissipation” in FIG. 7). Further, the first solenoid valve 36 is closed, and so the first heat exchange medium that has passed through the first heat exchanger 32 flows from the connection point 12B into the pipe 18.

The first heat exchange medium that has flowed into the pipe 18 flows from the connection point 12D into the pipe 26 and is reduced to a low pressure by the second expansion valve 46. Then, the first heat exchange medium evaporates and cools air in the proximity of the evaporator 48 as the first heat exchange medium passes through the evaporator 48 (see “heat absorption” in FIG. 7), thereby dehumidifying the air in the proximity of the evaporator 48. The first heat exchange medium that has passed through the evaporator 48 is drawn into the compressor 30 again via the pipe 28.

Moreover, in cases in which the heating demand continues to decrease even after closing the first solenoid valve 36, determination at step 226 is affirmative and processing transitions to step 230. At step 230, the air-conditioning control ECU 102 instructs the cooling water control ECU 120 to increase the opening amount of the flow rate regulating valve 76, and processing returns to step 209.

Note that instruction to the cooling water control ECU 120 at step 230 may instruct a change amount of the opening amount of the flow rate regulating valve 76 or may instruct a target opening amount of the flow rate regulating valve 76, or the change amount of the opening amount may be determined by the cooling water control ECU 120. In cases in which the cooling water control ECU 120 is instructed with a change amount of the opening amount of the flow rate regulating valve 76, the change amount of the opening amount may be changed to a fixed value on each occasion, or may change. Further, an instruction may be output to the cooling water control ECU 120 each time determination at step 226 is affirmative, or instructions may be output to the cooling water control ECU 120 at fixed intervals while determination at step 226 is affirmative.

When the cooling water control ECU 120 receives instruction from the air-conditioning control ECU 102, the cooling water control ECU 120 uses the valve drive section 134 to increase the opening amount of the flow rate regulating valve 76. The cooling water is thereby circulated in the second circulation path 56 along the path illustrated by arrows F in FIG. 7.

Namely, the cooling water discharged from the WP 68 branches at the connection point 56A and flows into the pipes 60, 64. The cooling water that has flowed into the pipe 60 dissipates heat by passing through the radiator 74, and then flows into the pipe 62. Note that the flow rate of the cooling water passing through the radiator 74 increases as the opening amount of the flow rate regulating valve 76 increases, and the amount of heat dissipated by the radiator 74 also increases accompanying this increase. The cooling water that has flowed into the pipe 64 is heated while passing through the secondary side of the first heat exchanger 32. As the cooling water passes through the heater core 78, the cooling water heats the air in the proximity of the heater core 78 in the HVAC unit 80, and then flows into the pipe 66. The cooling water that has flowed into the pipes 62, 66 merges at the connection point 56B, flows into the pipe 58, and is drawn into the WP 68.

Accordingly, during the late stage of the dehumidifying-heating operation, some of the heat that was transferred from the first heat exchange medium to the cooling water in the first heat exchanger 32 is dissipated in the radiator 74. Accordingly, the amount of heat dissipated by the heater core 78 is decreased according to the decreased heating demand and the temperature of the cooling water in the second circulation path 56 is suppressed from rising excessively, enabling an appropriate temperature (a temperature in a range of, for example, 50° C. to 80° C.) to be maintained and the amount of work in the first circulator section to be suppressed, thereby improving energy usage efficiency.

Balancing heat absorption and dissipation in the closed circuit of the heat exchange medium circulation path 302, the vehicle heat management system 300 according to the comparative example described earlier enables a refrigeration cycle to be established, even in cases in which the heating demand decreases with respect to the dehumidification demand during the dehumidifying-heating operation. However, in the comparative example, establishing a refrigeration cycle in a closed circuit requires electric expansion valves to be employed for the first expansion valve 326 and the second expansion valve 338 disposed at the front and at the rear of the exterior heat exchanger 330, and also requires the accumulator tank 320 that takes up a large amount of space.

On the other hand, in the vehicle heat management system 10A according to the first exemplary embodiment, the exterior heat exchanger 38 and the evaporator 48 are connected in parallel, and the flow rate of cooling medium passing through the evaporator 48 is controlled by the second expansion valve 46 during dehumidifying-heating operation. This enables a mechanical expansion valve to be employed as the second expansion valve 46, and enables costs and the space necessary for installation to be reduced because the accumulator tank is rendered unnecessary.

Further, in cases in which the heating demand decreases relative to the dehumidification demand during dehumidifying-heating operation, the vehicle heat management system 10A increases the opening amount of the flow rate regulating valve 76 so as to increase the flow rate of the cooling water passing through the radiator 74 in the second circulation path 56. Thus, excess heat in the first circulation path 12 is transferred to the second circulation path 56 side by the first heat exchanger 32 and heat is dissipated by the radiator 74, enabling the first heat exchange medium in the first circulation path 12 to be prevented from overheating.

Further, in cases in which the heating demand is decreased relative to the dehumidification demand during dehumidifying-heating operation, the vehicle heat management system 10A decreases the flow rate of the first heat exchange medium in the exterior heat exchanger 38 before increasing the flow rate of the cooling water passing through the radiator 74. Thus, the amount of heat absorption in the exterior heat exchanger 38 decreases, thereby decreasing the amount of work done by the compressor 30 and decreasing the amount of heat transfer (heat dissipation) in the first heat exchanger 32, enabling energy usage efficiency to be improved.

Accordingly, in cases in which the heating demand is decreased relative to the dehumidification demand during dehumidifying-heating operation, the vehicle heat management system 10A enables implementation of heat management as required to be implemented in a configuration that is low in cost and saves space.

### Second Exemplary Embodiment

Next, explanation follows regarding a second exemplary embodiment of the present description. Note that portions that are the same as that in the first exemplary embodiment are appended with the same reference numerals and explanation thereof is omitted, and explanation will be given regarding only portions which differ from those of the first exemplary embodiment.

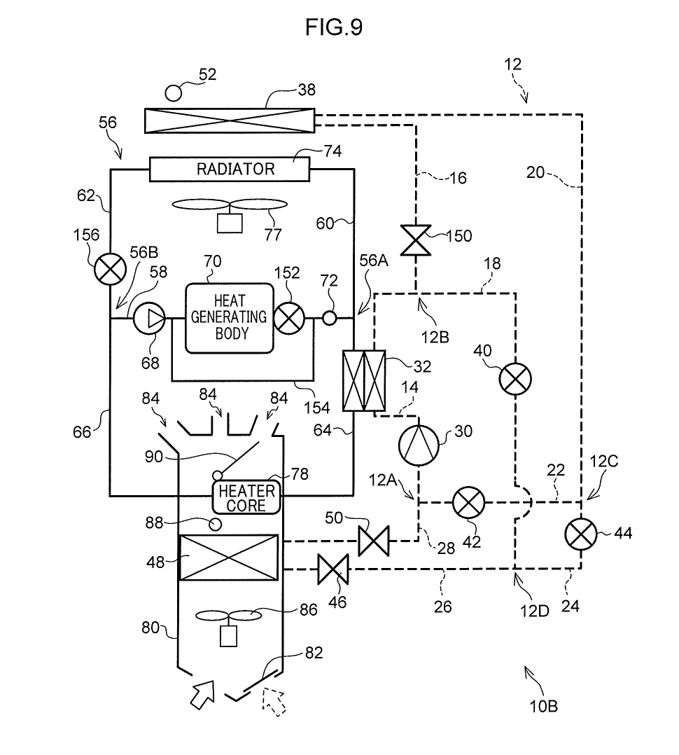

As illustrated in FIG. 9, in a vehicle heat management system 10B according to the second exemplary embodiment, a fully closable electric expansion valve 150, is provided partway along the pipe 16 of the first circulation path 12, in place of the first expansion valve 34 and the first solenoid valve 36. A solenoid valve 152 is provided partway along the pipe 58 of the second circulation path 56, at a position between the heat generating body 70 and the water temperature sensor 72. One end of a bypass pipe 154 is connected partway along the pipe 58, at a position between the WP 68 and the heat generating body 70. Another end of the bypass pipe 154 is connected partway along the pipe 58, at a position between the solenoid valve 152 and the water temperature sensor 72. Further, partway along the pipe 62, in place of the flow rate regulating valve 76, an electric thermostat 156 with a valve-opening temperature that can be changed by the cooling water control ECU 120 is provided.

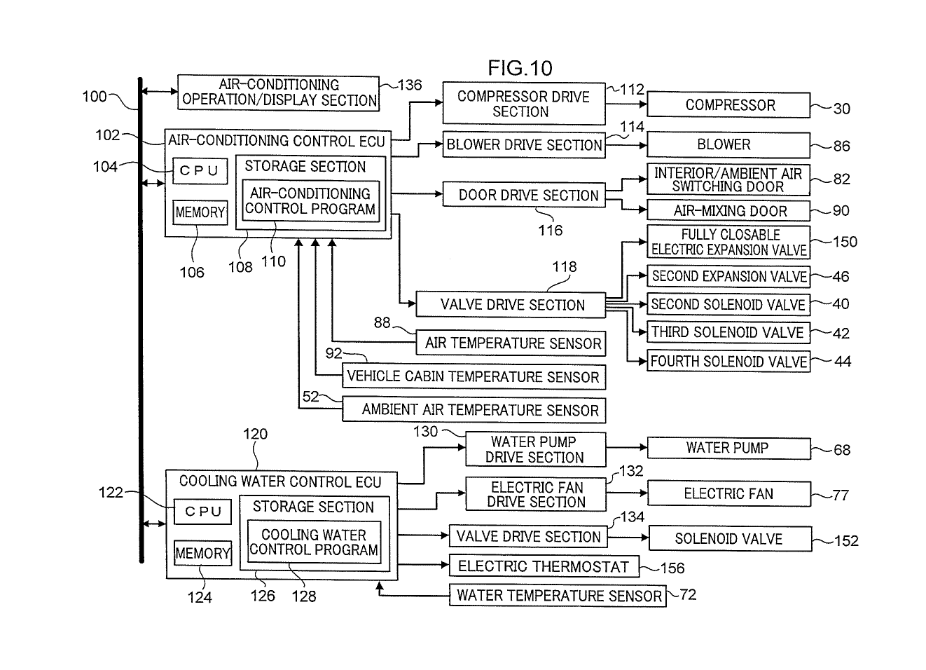

As illustrated in FIG. 10, the fully closable electric expansion valve 150 is connected to the valve drive section 118, the solenoid valve 152 is connected to the valve drive section 134, and the electric thermostat 156 is connected to the cooling water control ECU 120. Note that in the second exemplary embodiment, the air-conditioning control ECU 102, the cooling water control ECU 120, and the electric thermostat 156 are an example of a flow rate change section of the present description.

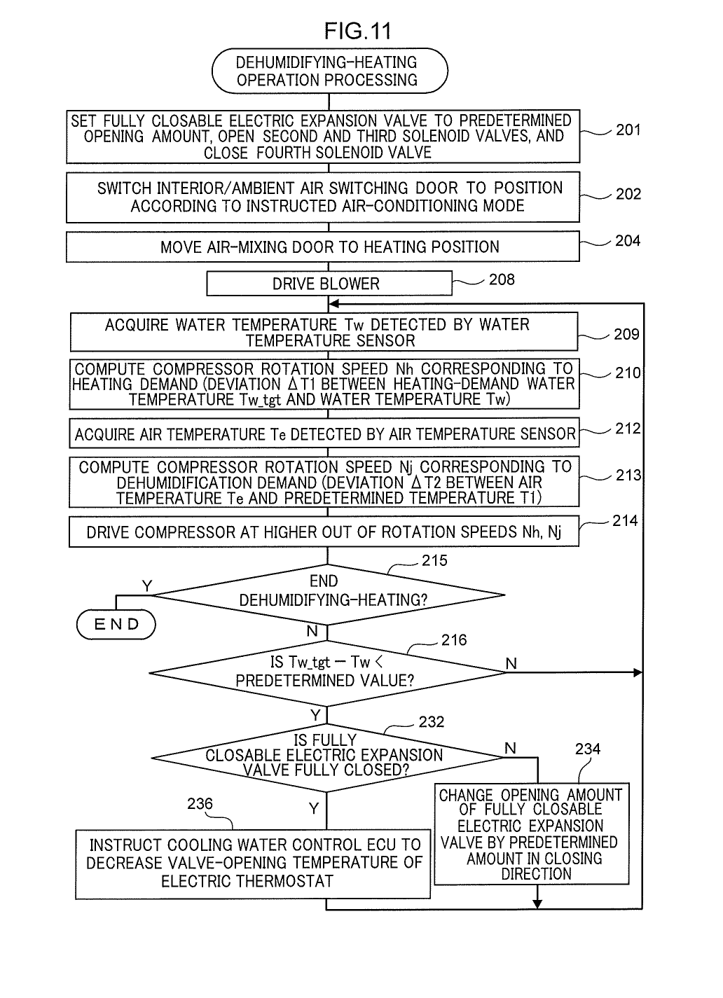

As illustrated in FIG. 11, compared to in the dehumidifying-heating operation processing according to the first exemplary embodiment (FIG. 5), in the dehumidifying-heating operation processing according to the second exemplary embodiment, step 201 is performed in place of step 200, step 206 is omitted, and steps 232 to 236 are performed instead of steps 222 to 230. Namely, at step 201, the air-conditioning control ECU 102 sets the fully closable electric expansion valve 150 to a predetermined opening amount using the valve drive section 118 in order to reduce the pressure of the first heat exchange medium. Further, the air-conditioning control ECU 102 uses the valve drive section 118 to open the first solenoid valve 36, the second solenoid valve 40, and the third solenoid valve 42, and to close the fourth solenoid valve 44.

When the heating demand decreases relative to the dehumidification demand during the dehumidifying-heating operation, determination at step 216 is affirmative, and processing transitions to step 232. At step 232, the air-conditioning control ECU 102 determines whether or not the fully closable electric expansion valve 150 is fully closed. In cases in which determination at step 232 is negative, processing transitions to step 234. At step 234, the air-conditioning control ECU 102 uses the valve drive section 118 to change the opening amount of the fully closable electric expansion valve 150 by a predetermined amount in the closing direction, and processing returns to step 209. Thus, the flow rate of the first heat exchange medium in the exterior heat exchanger 38 decreases, and the amount of heat transfer from the first heat exchange medium to the cooling water in the first heat exchanger 32 decreases, thereby decreasing the amount of heat dissipated by the heater core 78.

Each time determination is negative at step 232, the opening amount of the fully closable electric expansion valve 150 is changed at step 234. However, in cases in which the heating demand continues to decrease even after fully closing the fully closable electric expansion valve 150, determination is affirmative at step 232, and processing transitions to step 236. At step 236, the air-conditioning control ECU 102 instructs the cooling water control ECU 120 to decrease the valve-opening temperature of the electric thermostat 156, and processing returns to step 209.

When instructed by the air-conditioning control ECU 102, the cooling water control ECU 120 decreases the valve-opening temperature of the electric thermostat 156. Thus, the electric thermostat 156 opens at earlier stage than in cases in which the valve-opening temperature of the electric thermostat 156 is not changed, and heat is dissipated by cooling water passing through the radiator 74 of the second circulation path 56.

Further, the cooling water management device of the vehicle heat management system 10B is provided with the solenoid valve 152 and the bypass pipe 154 in the second circulation path 56. Thus, the solenoid valve 152 closes during warm-up of the heat generating body 70, thus setting the flow rate of cooling water passing through the heat generating body 70 to 0. Warm-up of the heat generating body 70 thereby completes in a short period of time compared to cases in which cooling water passes through the heat generating body 70.

### Third Exemplary Embodiment

Next, explanation follows regarding a third exemplary embodiment of the present description. Note that portions that are the same as that in the first exemplary embodiment are appended with the same reference numerals and explanation thereof is omitted, and explanation will be given regarding only portions which differ from those of the first exemplary embodiment.

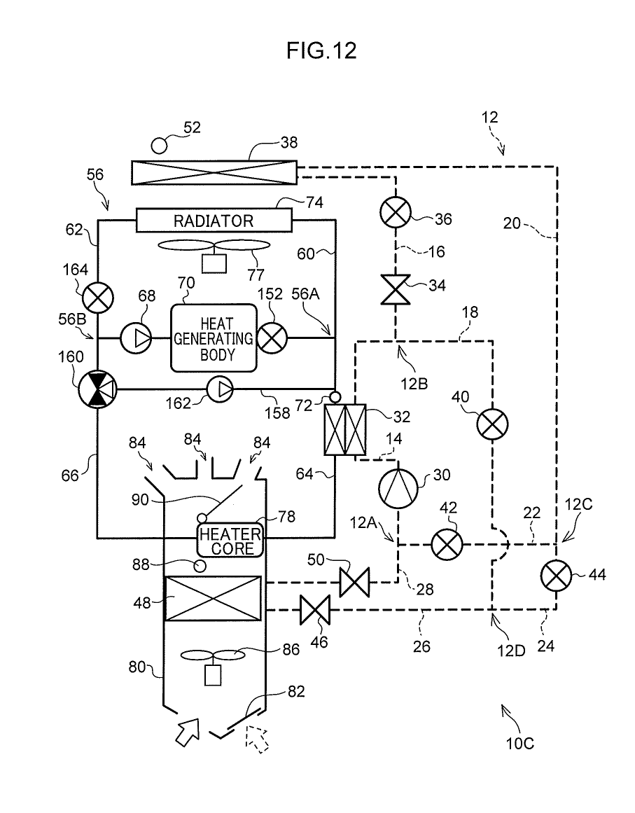

As illustrated in FIG. 12, a vehicle heat management system 10C according to the third exemplary embodiment is provided with a solenoid valve 152 partway along the pipe 58 of the second circulation path 56. One end of a bypass pipe 158 is connected partway along the pipe 64 at a position between the connection point 56A and the first heat exchanger 32. Another end of the bypass pipe 158 is connected to a three-way valve 160 provided partway along the pipe 66. The water temperature sensor 72 is provided partway along the pipe 64, between the connection point between the pipe 64 and the bypass pipe 158, and the first heat exchanger 32.

The three-way valve 160 selectively connects the pipe of the pipe 66 on the heater core 78 side of the three-way valve 160 to either the pipe of the pipe 66 on the opposite side of the three-way valve 160 to the heater core 78 or to the bypass pipe 158. A second WP 162 is provided partway along the bypass pipe 158. A mechanical thermostat 164 is provided partway along the pipe 62 in place of the flow rate regulating valve 76. In the third exemplary embodiment, the mechanical thermostat 164 is an example of a flow rate change section of the present description.

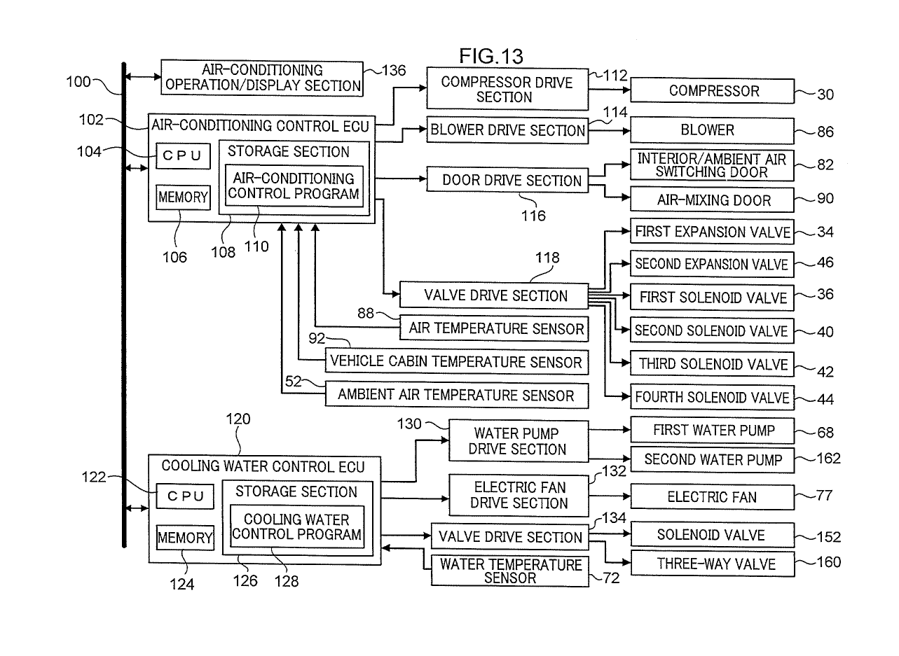

As illustrated in FIG. 13, the second WP 162 is connected to the WP drive section 130, and the solenoid valve 152 and the three-way valve 160 are each connected to the valve drive section 134. During warm-up of the heat generating body 70, the three-way valve 160 switches between connecting the pipe of the pipe 66 on the heater core 78 side of the three-way valve 160 to the bypass pipe 158, and connecting the pipe 66 where the pipe 66 is on the opposite side of the three-way valve 160 to the heater core 78 to the bypass pipe 158 after warm-up has been completed. Warm-up of the heat generating body 70 is thereby completed in a short period of time compared to cases in which cooling water passes through the heat generating body 70.

The dehumidifying-heating operation processing according to the third exemplary embodiment differs from the dehumidifying-heating operation processing explained in the first exemplary embodiment (FIG. 5) only in the point that steps 206, 230 are omitted, and so the dehumidifying-heating operation processing according to the third exemplary embodiment is not illustrated in the drawings. In the third exemplary embodiment, the air-conditioning control ECU 102 does not particularly perform any processing in cases in which the heating demand continues to decrease even after closing the first solenoid valve 36. Thus, in cases in which the mechanical thermostat 164 is closed, the temperature of the first heat exchange medium circulating in the first circulation path 12 and the temperature of the cooling water circulating in the second circulation path 56 each rise.

However, when the temperature of the cooling water reaches the valve-opening temperature of the mechanical thermostat 164, the mechanical thermostat 164 opens, and heat is dissipated as a result of cooling water passing through the radiator 74 of the second circulation path 56. The temperature of the first heat exchange medium circulating in the first circulation path 12 and the temperature of the cooling water circulating in the second circulation path 56 accordingly decrease. In the third exemplary embodiment, the mechanical thermostat 164 is employed as the flow rate change section, enabling simplification of the configuration of the vehicle heat management system 10C to be realized.

Note that in the third exemplary embodiment, in cases in which the heating demand continues to decrease even after closing the first solenoid valve 36, the air-conditioning control ECU 102 may perform processing to change the position of the air-mixing door 90 so as to decrease the temperature of the air supplied to the vehicle cabin interior.

### Fourth Exemplary Embodiment

Next, explanation follows regarding a fourth exemplary embodiment of the present description. Note that portions that are the same as that in the second exemplary embodiment are appended with the same reference numerals and explanation thereof is omitted, and explanation will be given regarding only portions which differ from those of the second exemplary embodiment.

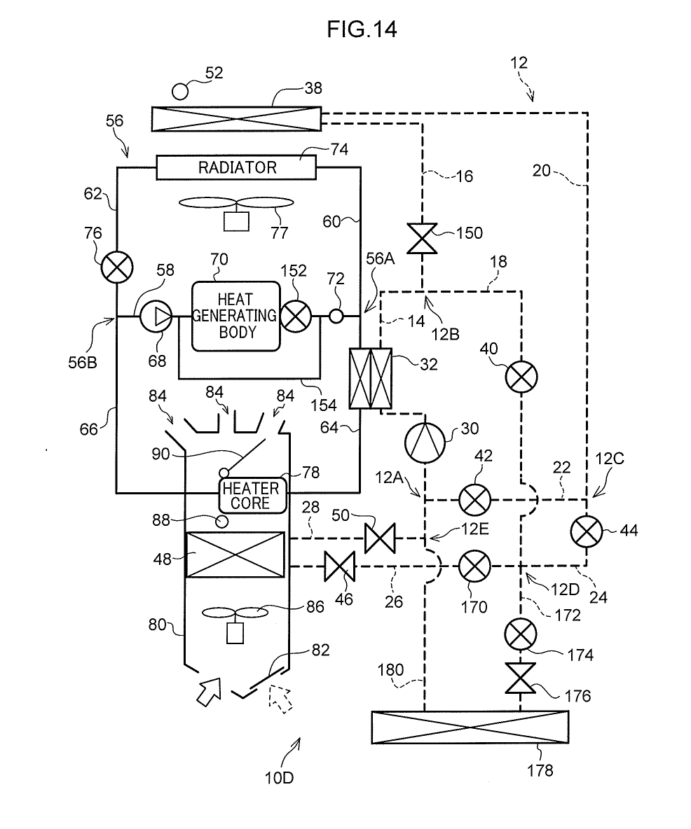

As illustrated in FIG. 14, a vehicle heat management system 10D according to the fourth exemplary embodiment includes a fifth solenoid valve 170 provided partway along the pipe 26, at a position between the connection point 12D and the second expansion valve 46. Further, in addition to the ends of the pipes 18, 24, and 26, one end of a pipe 172 is also connected to the connection point 12D of the first circulation path 12. Another end of the pipe 172 is connected to a heat-exchange-medium inflow side of a third heat exchanger 178. A sixth solenoid valve 174 and a second expansion valve 176 are provided in sequence along the pipe 172.

The third heat exchanger 178 is disposed adjacent to a battery (not illustrated in the drawings) installed in the vehicle, and in cases in which the temperature of the battery is a predetermined value or greater, the third heat exchanger 178 absorbs heat from the battery to cool the battery. The third heat exchanger 178 is an example of a heat absorption section of the present description. One end of a pipe 180 is connected to a heat-exchange-medium outflow side of the third heat exchanger 178. Another end of the pipe 180 is connected to the pipe 28, at a connection point 12E present partway along the pipe 28.

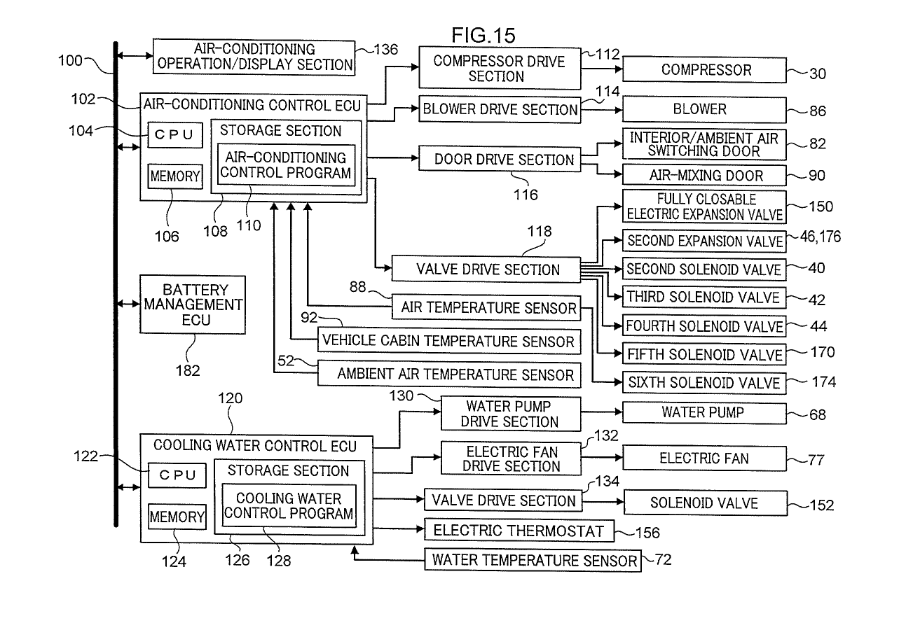

As illustrated in FIG. 15, the fifth solenoid valve 170, the sixth solenoid valve 174, and the second expansion valve 176 are each connected to the valve drive section 118. Further, a battery management ECU 182 is connected to the bus 100. A temperature sensor for detecting the temperature of the battery is connected to the battery management ECU 182, and in cases in which the temperature of the battery detected by the temperature sensor is the predetermined value or greater, the temperature sensor outputs a battery cooling request to the air-conditioning control ECU 102.

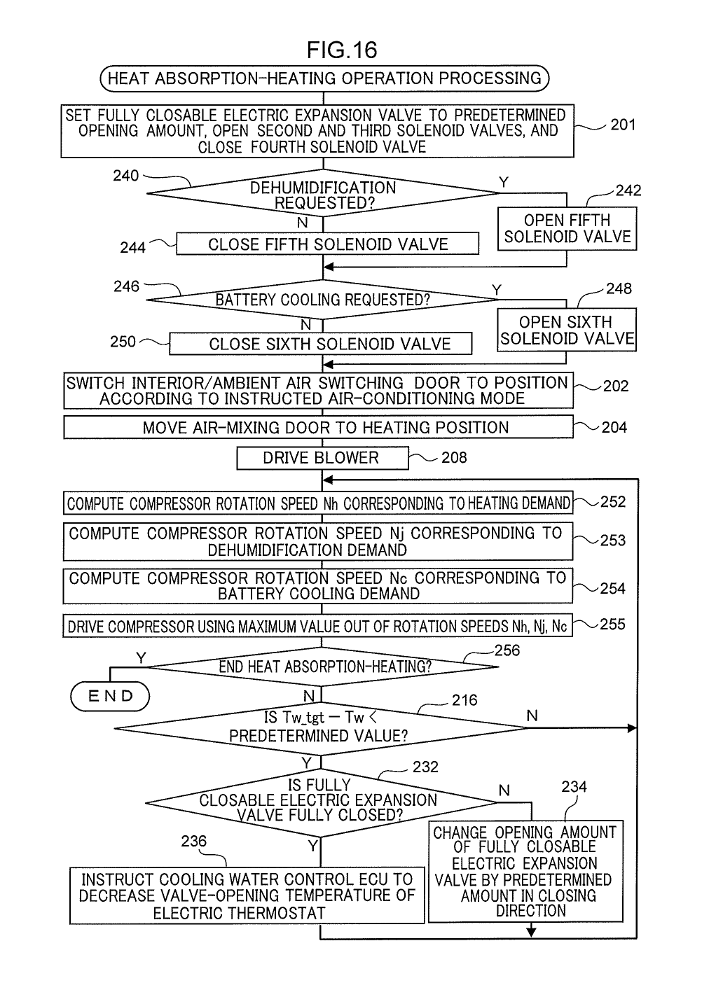

The air-conditioning control ECU 102 according to the fourth exemplary embodiment heats the vehicle cabin interior under instruction via the air-conditioning operation/display section 136, and performs the heat absorption-heating operation processing illustrated in FIG. 16 in cases in which at least one out of dehumidification of the vehicle cabin interior or cooling of the battery is to be performed. The state of heating the vehicle cabin interior, and performing at least one out of dehumidification of the vehicle cabin interior or cooling of the battery, is referred to as heat absorption-heating operation below.

In the heat absorption-heating operation processing, the air-conditioning control ECU 102 performs the processing at step 201, followed by determining whether or not dehumidification of the vehicle cabin interior is being requested via the air-conditioning operation/display section 136 at step 240. In cases in which determine is affirmative at step 240, processing transitions to step 242, and the air-conditioning control ECU 102 opens the fifth solenoid valve 170 using the valve drive section 118. When this is performed, the first heat exchange medium flows from the connection point 12D into the pipe 26, and heat absorption (dehumidification) is performed in the evaporator 48. In cases in which determination is negative at step 242, processing transitions to step 244, and the air-conditioning control ECU 102 closes the fifth solenoid valve 170 using the valve drive section 118. When this is performed, heat absorption is not performed in the evaporator 48.

At step 246, the air-conditioning control ECU 102 determines whether or not the battery management ECU 182 is requesting for the battery to be cooled. In cases in which determine is affirmative at step 246, processing transitions to step 248, and the air-conditioning control ECU 102 opens the sixth solenoid valve 174 using the valve drive section 118. When this is performed, the first heat exchange medium flows from the connection point 12D into the pipe 172, and heat absorption from the battery (battery cooling) is performed by the third heat exchanger 178. In cases in which determination is negative at step 246, processing transitions to step 250, and the air-conditioning control ECU 102 closes the sixth solenoid valve 174 using the valve drive section 118. When this is performed, heat absorption from the battery is not performed by the third heat exchanger 178. Note that in the heat absorption-heating operation processing in FIG. 16, determination of at least one out of steps 240, 246 is affirmative.

After performing the processing of step 208, at step 252, the air-conditioning control ECU 102 computes the revolution speed Nh of the compressor 30 according to the heating demand (deviation ΔT1=Tw_tgt−Tw), similarly to at steps 209, 210 described in the first exemplary embodiment. At the next step 253, the air-conditioning control ECU 102 computes the revolution speed Nj of the compressor 30 according to the dehumidification demand (deviation ΔT2=Te−T1), similarly to at steps 212, 213 described in the first exemplary embodiment. At step 254, the air-conditioning control ECU 102 sets a deviation ΔT3 of a battery setting temperature subtracted from the detected battery temperature as the battery cooling demand, and computes a revolution speed Nc of the compressor 30 according to the battery cooling demand (deviation ΔT3).

At the next step 255, the air-conditioning control ECU 102 selects the maximum value out of the revolution speed Nh computed at step 252, the revolution speed Nj computed at step 253, and the revolution speed Nc computed at step 254. The air-conditioning control ECU 102 then uses the compressor drive section 112 to drive the compressor 30 at the revolution speed corresponding to the maximum value out of the revolution speeds Nh, Nj, and Nc. Heat absorption-heating operation is thereby started.

At step 256, the air-conditioning control ECU 102 determines whether or not heat absorption-heating operation has completed. In cases in which heating of the vehicle cabin interior has completed or heat absorption by the evaporator 48 and the third heat exchanger 178 has completed, determination is affirmative at step 256, and in such cases, the heat absorption-heating operation processing is completed. Further, in cases in which determination at step 256 is negative, processing transitions to step 216, and the processing from step 216 onward is performed, similarly to in the second exemplary embodiment.

Note that the vehicle heat management device according to the present description is not limited to the configurations described in the first to the fourth exemplary embodiments. For example, the third solenoid valve 42 and the fourth solenoid valve 44 may be replaced by a single three-way valve disposed at connection point 12C. Further, for example, the second solenoid valve 40 and the second expansion valve 46 of the first to the third exemplary embodiments, the fifth solenoid valve and the second expansion valve 46 of the fourth exemplary embodiment, and the sixth solenoid valve 174 and the second expansion valve 176 of the fourth exemplary embodiment may be replaced by a single, fully closable electric expansion valve. The various valves included in the configurations described in the first to the fourth exemplary embodiments may be replaced with other valves having the same functionality thereof.

Further, explanation has been given embodiments in which, in cases in which the heating demand is decreased in dehumidifying-heating operation or heat absorption-heating operation, the flow rate of the first heat exchange medium in the exterior heat exchanger 38 is decreased and then the flow rate of the second heat exchange medium in the radiator 74 is increased. However, the scope of the rights of the present description includes embodiments in which, in cases in which the heating demand is decreased in dehumidifying-heating operation or heat absorption-heating operation, the flow rate of the second heat exchange medium in the radiator 74 is increased and then the flow rate of the first heat exchange medium in the exterior heat exchanger 38 is decreased.

What is claimed is:

1. A vehicle heat management device comprising:
a first circulator section that is provided at a first flow path of a first circulation path and that circulates a first heat exchange medium in the first circulation path, the first flow path passing a primary side of a first heat exchanger capable of exchanging heat between the primary side and a secondary side and being connected in parallel to a second flow path passing a first expansion valve and a second heat exchanger disposed at a cabin exterior, and a third flow path passing a second expansion valve and a heat absorption section disposed inside a vehicle;
a second circulator section that circulates a second heat exchange medium in a second circulation path configured by a fourth flow path passing a heat generating body of the vehicle, a fifth flow path passing a radiator, and a sixth flow path passing a heat dissipating section disposed inside the vehicle and the secondary side of the first heat exchanger, the fourth flow path, the fifth flow path, and the sixth flow path being connected in parallel with each other; and
a flow rate change section that, in cases in which, from a first state in which heat exchange is being performed in the first heat exchanger, heat absorption is being performed in the second heat exchanger and the heat absorption section, and heat dissipation is being performed in the heat dissipating section, a heat dissipation demand in the heat dissipating section has decreased relative to a heat absorption demand in the heat absorption section, increases a flow rate of the second heat exchange medium in the fifth flow path of the second circulation path.

2. The vehicle heat management device of claim 1, wherein the flow rate change section includes:
a first flow rate regulating section capable of regulating the flow rate of the second heat exchange medium in the fifth flow path of the second circulation path; and
a first control section that, in cases in which, from the first state, the heat dissipation demand in the heat dissipating section has decreased relative to the heat absorption demand in the heat absorption section, controls the first flow rate regulating section to increase the flow rate of the second heat exchange medium in the fifth flow path.

3. The vehicle heat management device of claim 2, wherein:
the first flow rate regulating section includes a flow rate regulating valve provided at the fifth flow path; and
the first control section increases an opening amount of the flow rate regulating valve to increase the flow rate of the second heat exchange medium in the fifth flow path.

4. The vehicle heat management device of claim 2, wherein:
the first flow rate regulating section includes an electric thermostat that is provided at the fifth flow path and that is capable of changing a valve-opening temperature; and
the first control section decreases the valve-opening temperature of the electric thermostat to increase the flow rate of the second heat exchange medium in the fifth flow path.

5. The vehicle heat management device of claim 1, wherein the flow rate change section includes a mechanical thermostat provided at the fifth flow path.

6. The vehicle heat management device of claim 1, further comprising a second control section that, in cases in which in the first state the heat dissipation demand in the heat dissipating section has decreased relative to the heat absorption demand in the heat absorption section, controls the first expansion valve so as to either decrease a flow rate or stop circulation of the first heat exchange medium in the second flow path of the first circulation path.

7. The vehicle heat management device of claim 2, further comprising a second control section that, in cases in which in the first state the heat dissipation demand in the heat dissipating section has decreased relative to the heat absorption demand in the heat absorption section, controls the first expansion valve so as to decrease a flow rate of the first heat exchange medium in the second flow path of the first circulation path before the first control section controls the first flow rate regulating section to increase the flow rate of the second heat exchange medium in the fifth flow path.

8. The vehicle heat management device of claim 1, wherein:
the heat generating body includes an engine installed in the vehicle; and
the second circulation path includes a bypass flow path that bypasses the engine, and a second flow rate regulating section capable of regulating the flow rate of the second heat exchange medium in the fourth flow path.

9. The vehicle heat management device of claim 1, wherein:
the heat absorption section includes an evaporator disposed together with the heat dissipating section in a duct through which airflow supplied into a vehicle cabin passes; and
the first state includes a dehumidifying-heating operation state in which airflow that has been dehumidified by the evaporator and heated by the heat dissipating section is supplied into the vehicle cabin.

10. The vehicle heat management device of claim 1, wherein the heat absorption section includes a third heat exchanger for cooling a battery installed to the vehicle.
